(19) United States
(12) Patent Application Publication
(10) Pub. No.: US 2017/0287356 A1
(43) Pub. Date: Oct. 5, 2017

(54) TEACHING SYSTEMS AND METHODS

(71) Applicant: ACCESSIBLE PUBLISHING SYSTEMS PTY LTD, Surry Hills, NSW (AU)

(72) Inventors: Christopher Colin Stephen, Woollahra (AU); Aswad Rehan Akram, Epping (AU); Ann Elizabeth Fitts, Woollahra, NSW (AU)

(21) Appl. No.: 15/513,956

(22) PCT Filed: Sep. 24, 2015
(86) PCT No.: PCT/AU2015/000583

§ 371 Date: Mar. 23, 2017

(30) Foreign Application Priority Data
Sep. 26, 2014 (AU) 2014903861

(51) Int. Cl. G09B 19/06; G09B 7/06; G09B 5/06

(52) U.S. Cl. CPC G09B 19/06; G09B 5/06; G09B 7/06

(57) ABSTRACT

A teaching system for teaching a user, the teaching system comprising a learning interface module (112), a user classification module (116) and a learning activity control module (114, 122), wherein: the learning interface module (112) is arranged to receive user information associated with a user and store the user information in a user information database (115); the user classification module (116) is arranged to obtain a user classification code based on the user information and store the user classification code in a learning outcome database (117), and the learning activity control module (114, 122) is arranged to select at least one learning activity from a learning activity database (118) based on the user classification code and communicate the selected learning activity to the learning interface module (112) for reception by the user.

### TECHNICAL FIELD

The present invention relates generally to teaching systems and methods.

### BACKGROUND

Education is becoming increasingly important in the 21st Century. Education is costing more. Education results are increasingly disappointing. People with learning difficulties are often being taught inadequately. Budget constraints are forcing cuts to education expenditure. A different approach is needed.

### SUMMARY

It is an object of the present invention to substantially overcome, or at least ameliorate, one or more disadvantages of existing arrangements.

Disclosed are arrangements which seek to address the above problems by providing improved systems and methods for teaching.

According to a first aspect of the present disclosure, there is provided a teaching system for teaching a user, the teaching system comprising a learning interface module, a user classification module and a learning activity control module, wherein: the learning interface module may be arranged to receive user information associated with a user and store the user information in a user information database; the user classification module may be arranged to obtain a user classification code based on the user information and store the user classification code in a learning outcome database, and the learning activity control module may be arranged to select at least one learning activity from a learning activity database based on the user classification code and communicate the selected learning activity to the learning interface module for reception by the user.

According to a second aspect of the present disclosure, there is provided a teaching system for teaching a user, the system comprising a learning interface module and a learning activity control module, wherein: the learning interface module is arranged to receive user interaction data associated with a user's interaction with a learning interface; and the learning activity control module is arranged to select at least one learning activity from a learning activity database and communicate the selected learning activity to the learning interface module for display on the learning interface, wherein the learning activity is arranged to utilise game processes with repetition.

According to a further aspect of the present disclosure, there is provided a computer implemented method for teaching a user, the method comprising the steps of a processor: generating a learning user interface to enable a user to interact with a learning activity, and generating a learning activity, wherein the learning activity is arranged to utilise game processes with repetition.

According to a further aspect of the present disclosure, there is provided a teaching system for teaching a user, the system comprising a learning interface module and a learning activity control module, wherein: the learning interface module is arranged to receive user interaction data associated with a user's interaction with a learning interface; and the learning activity control module is arranged to select at least one learning activity from a learning activity database and communicate the selected learning activity to the learning interface module for display on the learning interface, wherein the learning activity is a language learning activity arranged to output one sound per character of a word being taught.

According to a further aspect of the present disclosure, there is provided a computer implemented method for teaching a user, the method comprising the steps of a processor: generating a learning user interface to enable a user to interact with a learning activity, and generating a learning activity, wherein the learning activity is a language learning activity arranged to output one sound per character of a word being taught.

According to a further aspect of the present disclosure, there is provided a teaching system comprising a learning interface module and a learning activity control module, wherein: the learning interface module is arranged to receive user interaction data associated with a user's interaction with a learning interface; and the learning activity control module is arranged to select at least one learning activity from a learning activity database and communicate the selected learning activity to the learning interface module for display on the learning interface, wherein the learning activity is a language learning activity arranged to output a word using a word mark-up system that embeds a pronunciation guide for at least a portion of the word within the word without changing the spelling of the word.

According to a further aspect of the present disclosure, there is provided a computer implemented method for teaching a user, the method comprising the steps of a processor: generating a learning user interface to enable a user to interact with a learning activity, and generating a learning activity, wherein the learning activity is a language learning activity arranged to output a word using a word mark-up system that embeds a pronunciation guide for at least a portion of the word within the word without changing the spelling of the word.

According to a further aspect of the present disclosure, there is provided a teaching system comprising a learning interface module and a learning activity control module, wherein: the learning interface module is arranged to receive user interaction data associated with a user's interaction with a learning interface; and the learning activity control module is arranged to select at least one learning activity from a learning activity database and communicate the selected learning activity to the learning interface module for display on the learning interface, wherein the learning activity is arranged to output a word using a word mark-up system that embeds a pronunciation guide for at least a portion of the word within the word without changing the spelling of the word.

According to a further aspect of the present disclosure, there is provided a computer implemented method for teaching a user, the method comprising the steps of a processor: generating a learning user interface to enable a user to interact with a learning activity, and generating a learning activity, wherein the learning activity is arranged to output a word using a word mark-up system that embeds a pronunciation guide for at least a portion of the word within the word without changing the spelling of the word.

According to a further aspect of the present disclosure, there is provided a teaching system comprising a learning interface module and a learning activity control module, wherein: the learning interface module is arranged to receive user interaction data associated with a user's interaction with a learning interface; and the learning activity control module is arranged to select at least one learning activity from a learning activity database and communicate the selected learning activity to the learning interface module for display on the learning interface, wherein the learning activity is a language learning activity and is arranged to output, in order, phonemes of a word being taught, syllables of the word being taught and then the word being taught.

According to a further aspect of the present disclosure, there is provided a computer implemented method for teaching a user, the method comprising the steps of a processor: generating a learning user interface to enable a user to interact with a learning activity, and generating a learning activity, wherein the learning activity is a language learning activity and is arranged to output, in order, phonemes of a word being taught, syllables of the word being taught and then the word being taught.

According to a further aspect of the present disclosure, there is provided a teaching system comprising a learning interface module and a learning activity control module, wherein: the learning interface module is arranged to receive user interaction data associated with a user's interaction with a learning interface; and the learning activity control module is arranged to select at least one learning activity from a learning activity database and communicate the selected learning activity to the learning interface module for display on the learning interface, wherein the learning activity is a language learning activity and is arranged to separate a word being taught into its syllabic components and display the individual syllables of the word.

According to a further aspect of the present disclosure, there is provided a computer implemented method for teaching a user, the method comprising the steps of a processor: generating a learning user interface to enable a user to interact with a learning activity, and generating a learning activity, wherein the learning activity is a language learning activity and is arranged to separate a word being taught into its syllabic components and display the individual syllables of the word.

According to a further aspect of the present disclosure, there is provided a teaching system comprising a learning interface module and a learning activity control module, wherein: the learning interface module is arranged to receive user interaction data associated with a user's interaction with a learning interface; and the learning activity control module is arranged to select at least one learning activity from a learning activity database and communicate the selected learning activity to the learning interface module for display on the learning interface, wherein the learning activity is a language learning activity and is arranged to display silent characters in a word being taught in a different format to other characters in the word.

According to a further aspect of the present disclosure, there is provided a computer implemented method for teaching a user, the method comprising the steps of a processor: generating a learning user interface to enable a user to interact with a learning activity, and generating a learning activity, wherein the learning activity is a language learning activity and is arranged to display silent characters in a word being taught in a different format to other characters in the word.

According to a further aspect of the present disclosure, there is provided a teaching system comprising a learning interface module and a learning activity control module, wherein: the learning interface module is arranged to receive user interaction data associated with a user's interaction with a learning interface; and the learning activity control module is arranged to select at least one learning activity from a learning activity database and communicate the selected learning activity to the learning interface module for display on the learning interface, wherein the learning activity control module is further arranged to detect an accent selection from the user and the learning activity is arranged to output audio signals based on the accent selection.

According to a further aspect of the present disclosure, there is provided a computer implemented method for teaching a user, the method comprising the steps of a processor: generating a learning user interface to enable a user to interact with a learning activity and select an accent, and generating a learning activity, wherein the learning activity is a language learning activity and is arranged to output audio signals based on the selected accent.

According to a further aspect of the present disclosure, there is provided a teaching system comprising a learning interface module and a learning activity control module, wherein: the learning interface module is arranged to receive user interaction data associated with a user's interaction with a learning interface; and the learning activity control module is arranged to select at least one learning activity from a learning activity database and communicate the selected learning activity to the learning interface module for display on the learning interface, wherein the learning interface module is further arranged to capture pronunciation of at least a portion of a word, and wherein the learning activity is arranged to compare the captured pronunciation of words with a pre-stored pronunciation of at least a portion of the word.

According to a further aspect of the present disclosure, there is provided a computer implemented method for teaching a user, the method comprising the steps of a processor: generating a learning user interface to enable a user to interact with a learning activity and capture pronunciation of at least a portion of a word, and generating a learning activity, wherein the learning activity is a language learning activity and is arranged to compare the captured pronunciation of words with a pre-stored pronunciation of at least a portion of the word.

According to a further aspect of the present disclosure, there is provided a teaching system comprising a learning interface module and a learning activity control module, wherein: the learning interface module is arranged to receive user interaction data associated with a user's interaction with a learning interface; and the learning activity control module is arranged to select at least one learning activity from a learning activity database and communicate the selected learning activity to the learning interface module for display on the learning interface, wherein the learning activity is a language learning activity and is arranged to generate non-words.

According to a further aspect of the present disclosure, there is provided a computer implemented method for teaching a user, the method comprising the steps of a processor: generating a learning user interface to enable a user to interact with a learning activity and capture pronunciation of at least a portion of a word, and generating a learning activity, wherein the learning activity is a language learning activity and is arranged to generate non-words.

According to a further aspect of the present disclosure, there is provided a teaching system comprising a learning interface module and a learning activity control module, wherein: the learning interface module is arranged to receive user interaction data associated with a user's interaction with a learning interface; and the learning activity control module is arranged to select at least one learning activity from a learning activity database and communicate the selected learning activity to the learning interface module for display on the learning interface, wherein the learning activity control module is arranged to compare a first set of grammar rules associated with the native language of the user with a second set of grammar rules associated with the language being learnt by the user, and the learning activity is a language learning activity arranged to teach the rules that are different based on the comparison.

According to a further aspect of the present disclosure, there is provided a computer implemented method for teaching a user, the method comprising the steps of a processor: generating a learning user interface to enable a user to interact with a learning activity and compare a first set of grammar rules associated with the native language of the user with a second set of grammar rules associated with the language being learnt by the user, and generating a learning activity, wherein the learning activity is a language learning activity and is arranged to teach the rules that are different based on the comparison.

According to a further aspect of the present disclosure, there is provided a teaching system comprising a learning interface module and a learning activity control module, wherein: the learning interface module is arranged to receive user interaction data associated with a user's interaction with a learning interface; and the learning activity control module is arranged to select at least one learning activity from a learning activity database and communicate the selected learning activity to the learning interface module for display on the learning interface, and the learning activity is a language learning activity arranged to teach sight recognition of common syllables.

According to a further aspect of the present disclosure, there is provided a computer implemented method for teaching a user, the method comprising the steps of a processor: generating a learning user interface to enable a user to interact with a learning activity, and generating a learning activity, wherein the learning activity is a language learning activity and is arranged to teach sight recognition of common syllables.

According to a further aspect of the present disclosure, there is provided a teaching system comprising a learning interface module and a learning activity control module, wherein: the learning interface module is arranged to receive user interaction data associated with a user's interaction with a learning interface; and the learning activity control module is arranged to select at least one learning activity from a learning activity database and communicate the selected learning activity to the learning interface module for display on the learning interface, and the learning activity is a language learning activity arranged to teach sight recognition of words by flashing words on the learning interface.

According to a further aspect of the present disclosure, there is provided a computer implemented method for teaching a user, the method comprising the steps of a processor: generating a learning user interface to enable a user to interact with a learning activity, and generating a learning activity, wherein the learning activity is a language learning activity and is arranged to teach sight recognition of words by flashing words on the learning interface.

According to a further aspect of the present disclosure, there is provided a teaching system comprising a learning interface module and a learning activity control module, wherein: the learning interface module is arranged to receive user interaction data associated with a user's interaction with a learning interface; and the learning activity control module is arranged to select at least one learning activity from a learning activity database and communicate the selected learning activity to the learning interface module for display on the learning interface, and the learning activity control module is further arranged to measure hesitation while the user interacts with the learning activity and analyze the hesitation to measure automaticity of the interaction.

According to a further aspect of the present disclosure, there is provided a computer implemented method for teaching a user, the method comprising the steps of a processor: generating a learning user interface to enable a user to interact with a learning activity, generating a learning activity, wherein the learning activity is a language learning activity, and measuring hesitation while the user interacts with the learning activity and analyze the hesitation to measure automaticity of the interaction.

According to a further aspect of the present disclosure, there is provided a computer implemented method for teaching a user, the method comprising the steps of a processor: receiving user information associated with a user and storing the user information; obtaining a user classification code based on the user information and storing the user classification code; selecting at least one learning activity from a learning activity database based on the user classification code; and communicating the selected learning activity to the user.

Other aspects of the present disclosure are also disclosed.

### BRIEF DESCRIPTION OF THE DRAWINGS

At least one embodiment of the present invention will now be described with reference to the drawings and appendices, in which:

FIGS. 1A and 1B form a schematic block diagram of a general purpose computer system upon which arrangements described can be practiced;

FIG. 10 shows a general system diagram according to the present disclosure;

FIG. 2 shows a user classification improvement system diagram according to the present disclosure;

FIG. 3 shows a design and/or create interface system diagram according to the present disclosure;

FIG. 4 shows a learning activity selector system diagram according to the present disclosure;

FIG. 5 shows a user interface according to the present disclosure;

FIG. 6 shows a user interface according to the present disclosure;

FIG. 7 shows a user interface according to the present disclosure;

FIG. 8 shows a user interface according to the present disclosure;

FIG. 9 shows a user interface according to the present disclosure;

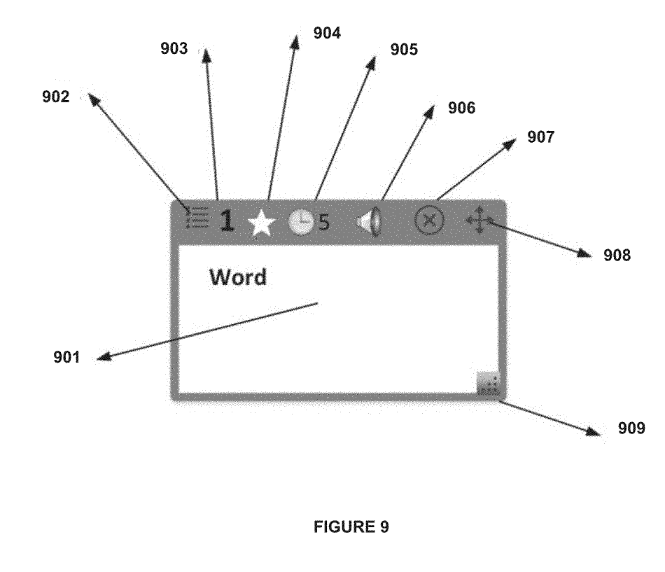

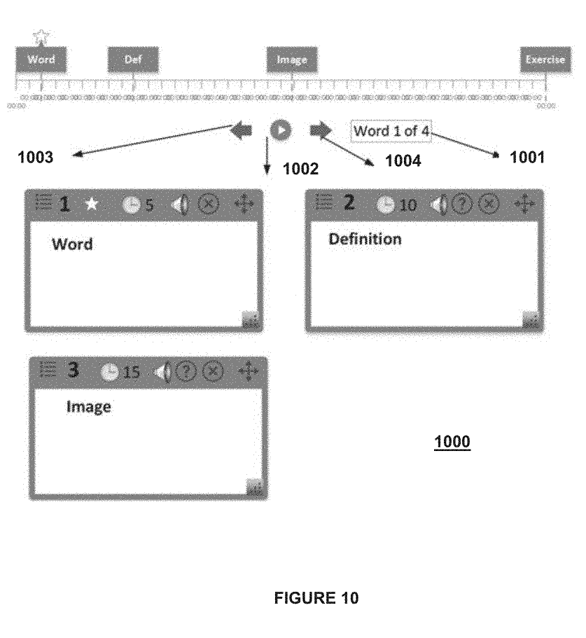

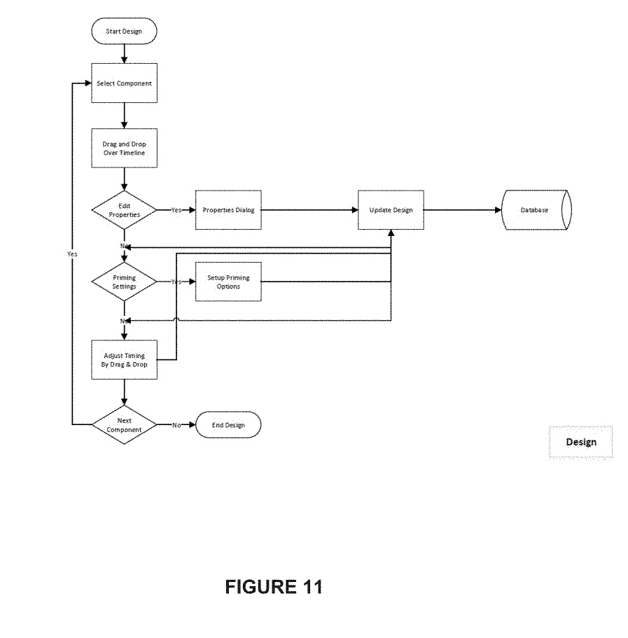

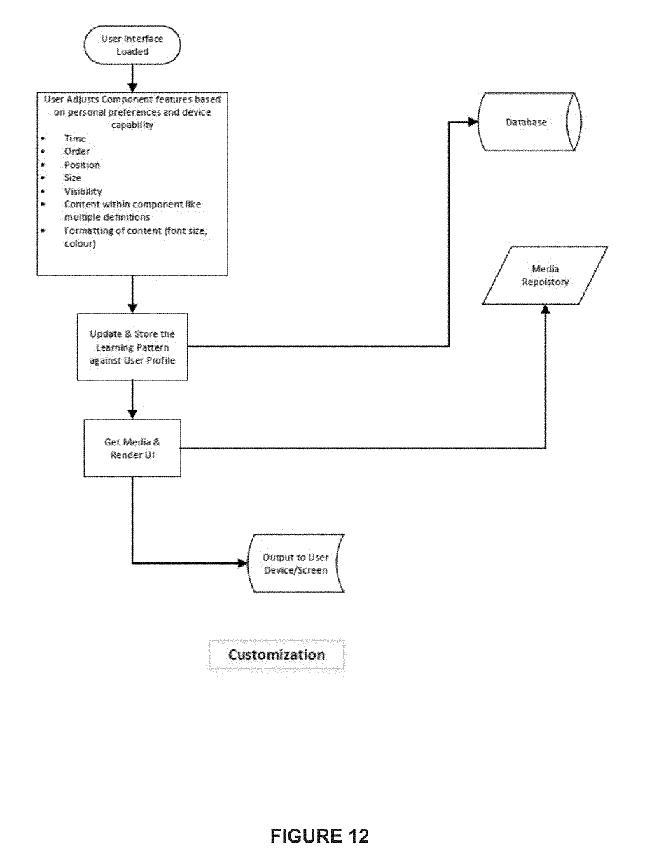

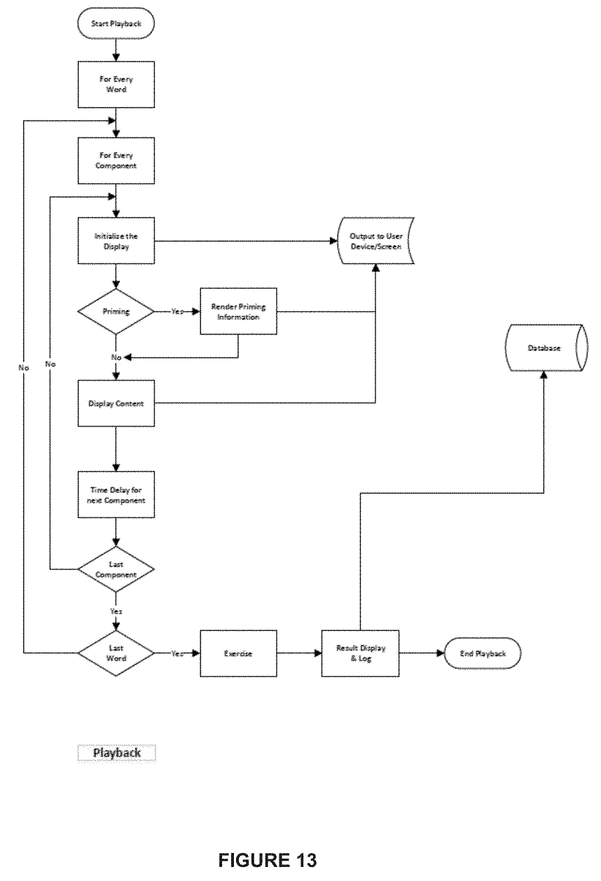

FIG. 10 shows a user interface according to the present disclosure;

FIG. 11 shows a flow diagram according to the present disclosure;

FIG. 12 shows a flow diagram according to the present disclosure;

FIG. 13 shows a flow diagram according to the present disclosure;

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

### Definitions

User Id: each user has a unique User ID to enable the system to uniquely identify them either solely based on that User Id or in combination with another code that utilises the User Id.

Learning Unit: This is a single bit of information that is being taught by the system. One or more Learning Units make up a Learning Activity. It could be the meaning of a word, the pronunciation of a phoneme or any other thing (including fact or skill) that can be learned by the user of the system.

Learning Tools are digital learning programs and include, display of text, playing of videos and audio information, Multiple Choice Questions (MCQ), games, online exercises, systems to measure the speed and accuracy of reading, online tests and combinations of the above. Each Learning Tool has a unique number.

Learning Activities (LA) include Learning Tools, videos, text, audio files and any other activity that assists. Each Learning Activity has a unique number. A Learning Activity may have one or more Learning Units.

Learning Pattern (LP) is a series of Learning Activities configured in a particular way and in a particular sequence to teach specific subject learning units to students. Each Learning Pattern will have a unique number. Variations of a Learning Pattern—e.g. the same Learning Pattern but with different customized interfaces—will have different version numbers.

Learning Pattern Class (LPC). Similar Learning Patterns can be classified in the same Learning Pattern Class. Initially Learning Patterns with the same Learning Activities will be classified in the Learning Pattern Class, irrespective of the order of the sequence of Learning Activities and the way the Learning Activities have been customized by students. Each Learn Pattern Class will have a unique number.

A Lesson is a Learning Pattern with defined Learning Units. Each Lesson has a unique number.

Learning Skill (LS) is the skill that the student is learning. In the case of a language learning application, learning skills and can include ability to decode the sound of written words, instant recognition of words by sight (sightword recognition), reading, comprehension, pronunciation, auditory discrimination, spelling, building vocabulary, and so on. Each Learning Activity will have at least one Learning Skill. Some Learning Activities can have more than one Learning Skill. Each Learning Skill has a unique number.

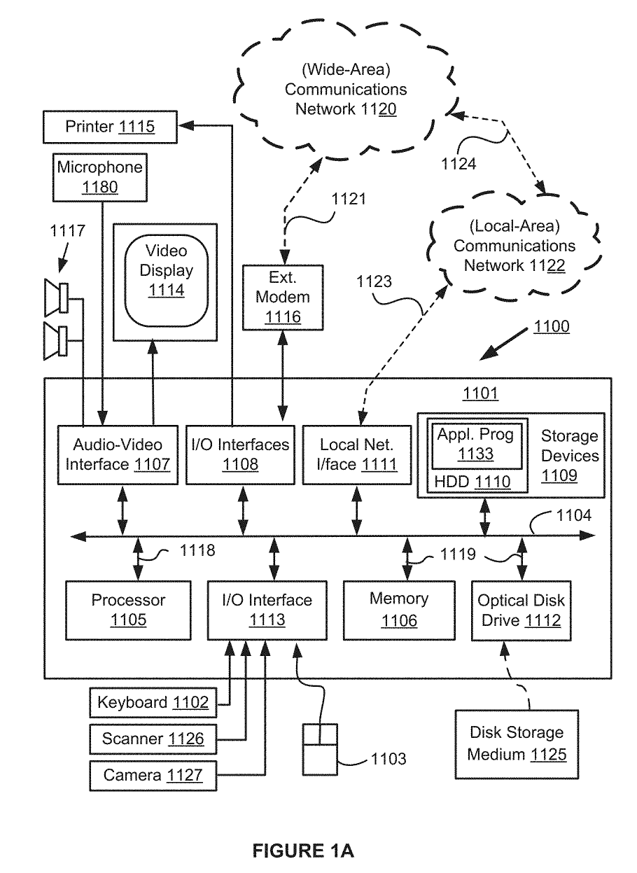

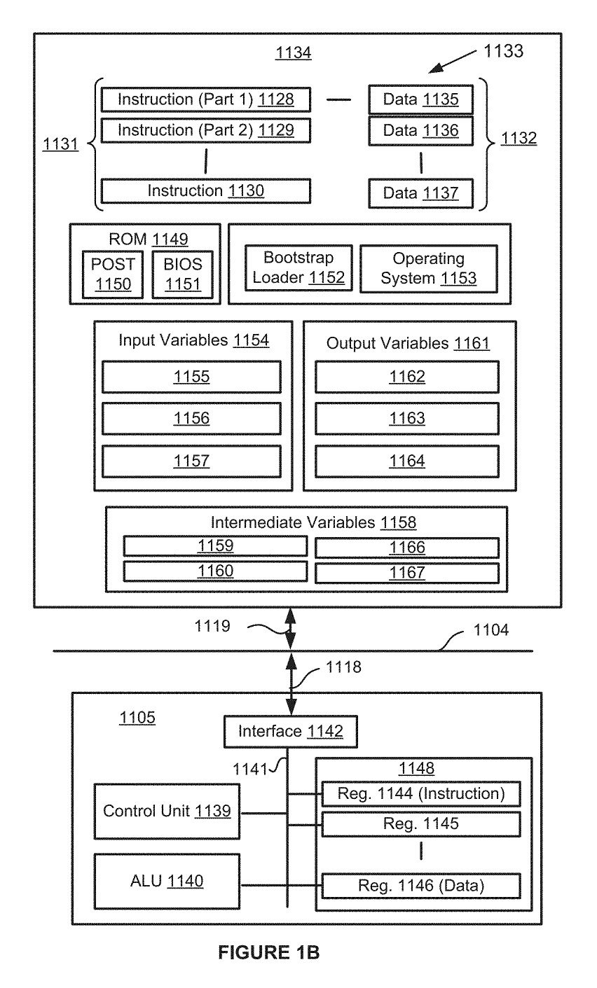

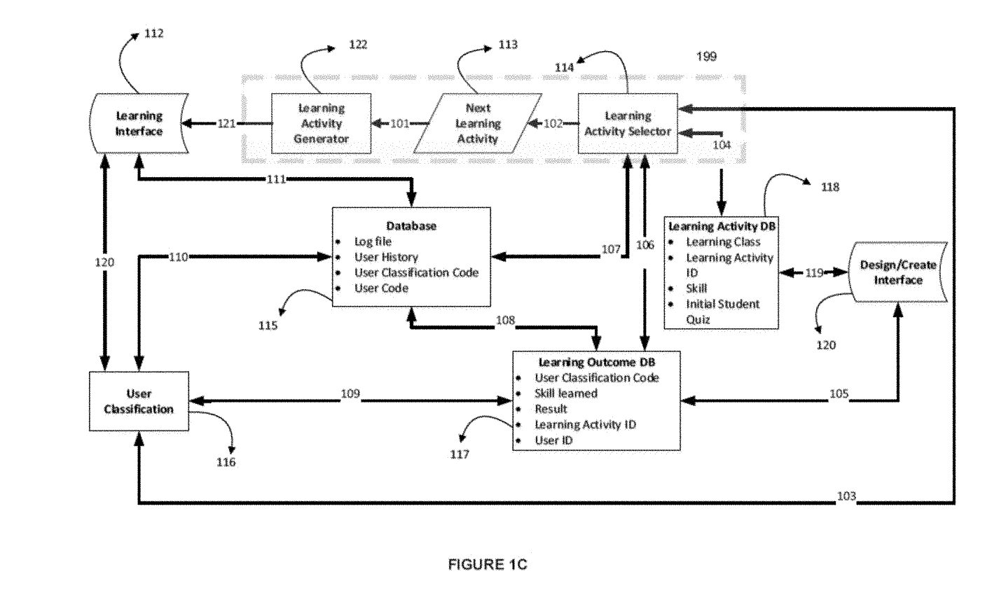

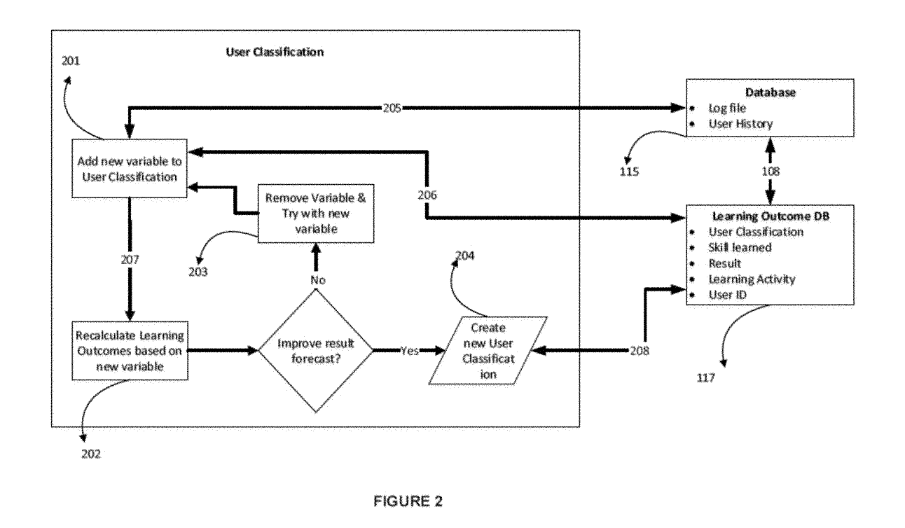

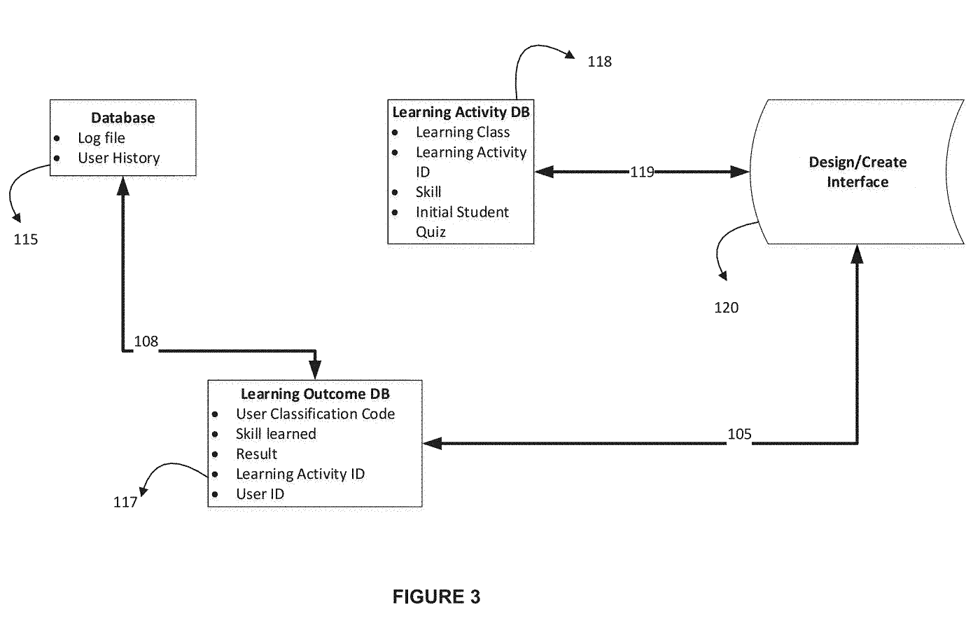

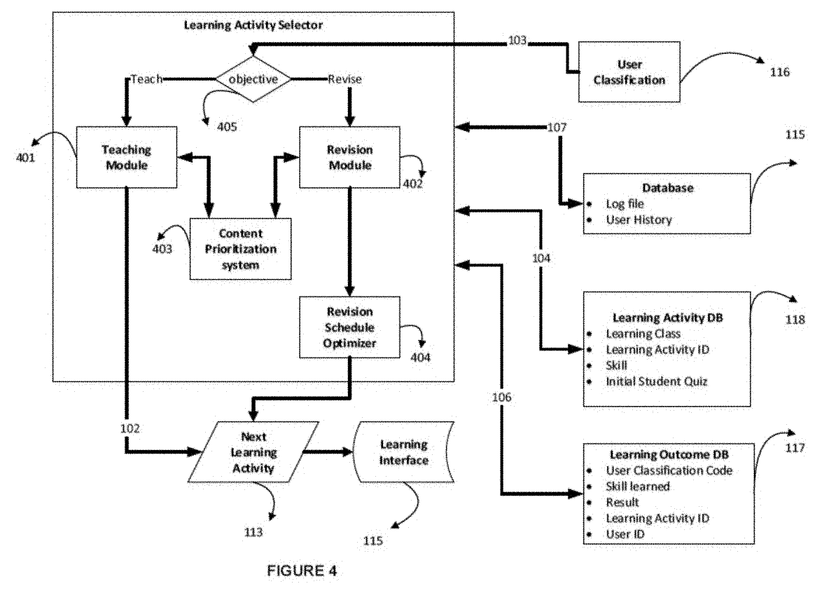

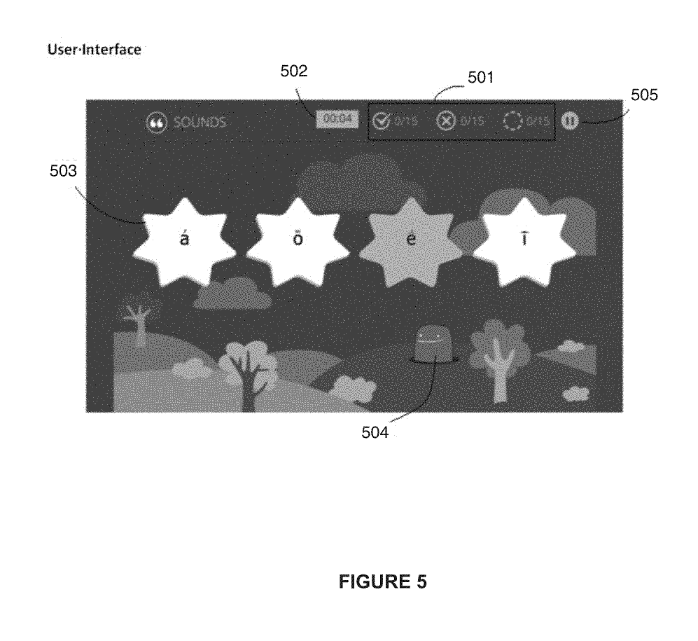

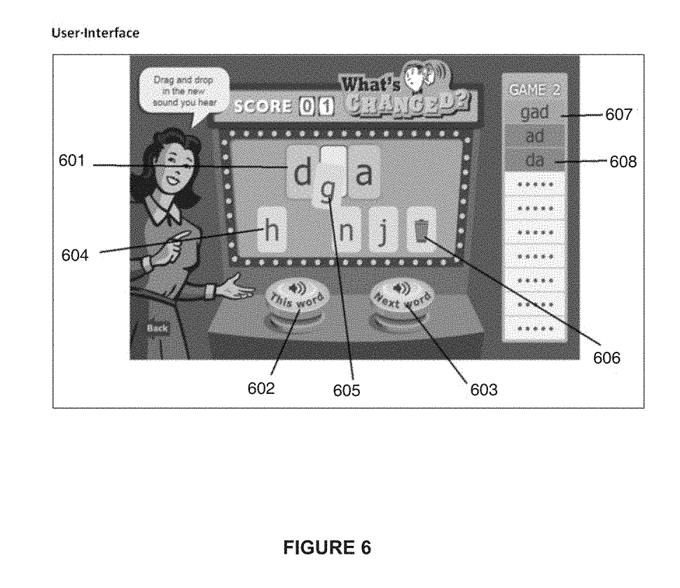

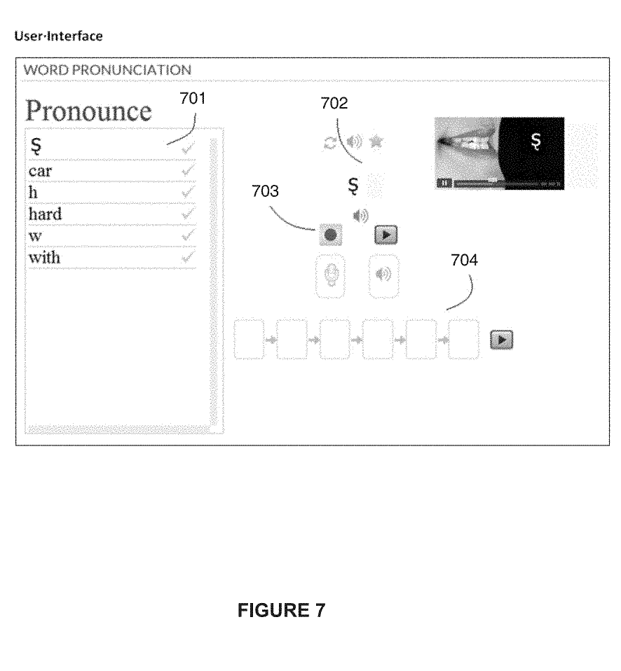

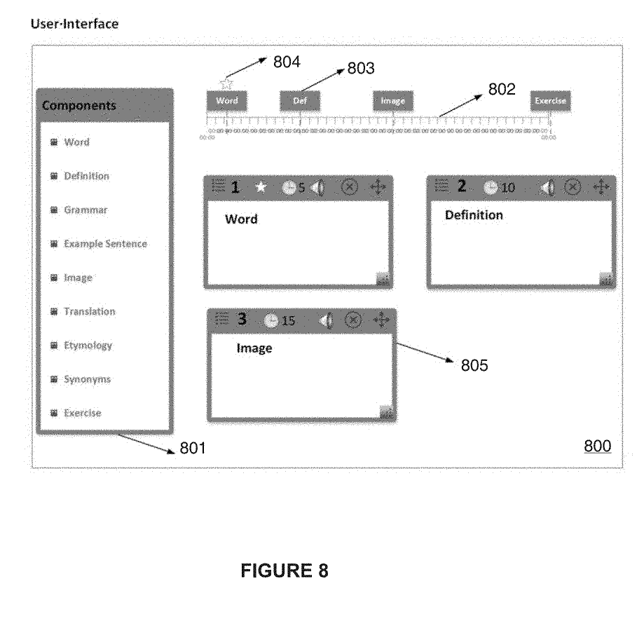

FIGS. 1A and 1B depict a general-purpose computer system 1100, upon which the various arrangements described can be practiced.

As seen in FIG. 1A, the computer system 1100 includes: a computer module 1101; input devices such as a keyboard 1102, a mouse pointer device 1103, a scanner 1126, a camera 1127, and a microphone 1180; and output devices including a printer 1115, a display device 1114 and loudspeakers 1117. An external Modulator-Demodulator (Modem) transceiver device 1116 may be used by the computer module 1101 for communicating to and from a communications network 1120 via a connection 1121. The communications network 1120 may be a wide-area network (WAN), such as the Internet, a cellular telecommunications network, or a private WAN. Where the connection 1121 is a telephone line, the modem 1116 may be a traditional “dial-up” modem. Alternatively, where the connection 1121 is a high capacity (e.g., cable) connection, the modem 1116 may be a broadband modem. A wireless modem may also be used for wireless connection to the communications network 1120.

The computer module 1101 typically includes at least one processor unit 1105, and a memory unit 1106. For example, the memory unit 1106 may have semiconductor random access memory (RAM) and semiconductor read only memory (ROM). The computer module 1101 also includes an number of input/output (I/O) interfaces including: an audio-video interface 1107 that couples to the video display 1114, loudspeakers 1117 and microphone 1180; an I/O interface 1113 that couples to the keyboard 1102, mouse 1103, scanner 1126, camera 1127 and optionally a joystick or other human interface device (not illustrated); and an interface 1108 for the external modem 1116 and printer 1115. In some implementations, the modem 1116 may be incorporated within the computer module 1101, for example within the interface 1108. The computer module 1101 also has a local network interface 1111, which permits coupling of the computer system 1100 via a connection 1123 to a local-area communications network 1122, known as a Local Area Network (LAN). As illustrated in FIG. 1A, the local communications network 1122 may also couple to the wide network 1120 via a connection 1124, which would typically include a so-called “firewall” device or device of similar functionality. The local network interface 1111 may comprise an Ethernet circuit card, a Bluetooth® wireless arrangement or an IEEE 802.11 wireless arrangement; however, numerous other types of interfaces may be practiced for the interface 1111.

The I/O interfaces 1108 and 1113 may afford either or both of serial and parallel connectivity, the former typically being implemented according to the Universal Serial Bus (USB) standards and having corresponding USB connectors (not illustrated). Storage devices 1109 are provided and typically include a hard disk drive (HDD) 1110. Other storage devices such as a floppy disk drive and a magnetic tape drive (not illustrated) may also be used. An optical disk drive 1112 is typically provided to act as a non-volatile source of data. Portable memory devices, such optical disks (e.g., CD-ROM, DVD, Blu-Ray Disc™), USB-RAM, portable, external hard drives, and floppy disks, for example, may be used as appropriate sources of data to the system 1100.

The components 1105 to 1113 of the computer module 1101 typically communicate via an interconnected bus 1104 and in a manner that results in a conventional mode of operation of the computer system 1100 known to those in the relevant art. For example, the processor 1105 is coupled to the system bus 1104 using a connection 1118. Likewise, the memory 1106 and optical disk drive 1112 are coupled to the system bus 1104 by connections 1119. Examples of computers on which the described arrangements can be practiced include IBM-PC's and compatibles, Sun Sparcstations, Apple Mac™ or a like computer systems.

The methods described herein may be implemented using the computer system 1100 wherein the various processes described, may be implemented as one or more software application programs 1133 executable within the computer system 1100. In particular, various steps of the methods described may be effected by instructions 1131 (see FIG. 1B) in the software 1133 that are carried out within the computer system 1100. The software instructions 1131 may be formed as one or more code modules, each for performing one or more particular tasks. The software may also be divided into two separate parts, in which a first part and the corresponding code modules perform a portion of the methods described and a second part and the corresponding code modules manage a user interface between the first part and the user.

The software may be stored in a computer readable medium, including the storage devices described below, for example. The software is loaded into the computer system 1100 from the computer readable medium, and then executed by the computer system 1100. A computer readable medium having such software or computer program recorded on the computer readable medium is a computer program product. The use of the computer program product in the computer system 1100 preferably effects an advantageous apparatus for a teaching system.

The software 1133 is typically stored in the HDD 1110 or the memory 1106. The software is loaded into the computer system 1100 from a computer readable medium, and executed by the computer system 1100. Thus, for example, the software 1133 may be stored on an optically readable disk storage medium (e.g., CD-ROM) 1125 that is read by the optical disk drive 1112. A computer readable medium having such software or computer program recorded on it is a computer program product. The use of the computer program product in the computer system 1100 preferably effects an apparatus for a teaching system.

In some instances, the application programs 1133 may be supplied to the user encoded on one or more CD-ROMs 1125 and read via the corresponding drive 1112, or alternatively may be read by the user from the networks 1120 or 1122. Still further, the software can also be loaded into the computer system 1100 from other computer readable media. Computer readable storage media refers to any non-transitory tangible storage medium that provides recorded instructions and/or data to the computer system 1100 for execution and/or processing. Examples of such storage media include floppy disks, magnetic tape, CD-ROM, DVD, Blu-Ray™ Disc, a hard disk drive, a ROM or integrated circuit, USB memory, a magneto-optical disk, or a computer readable card such as a PCMCIA card and the like, whether or not such devices are internal or external of the computer module 1101. Examples of transitory or non-tangible computer readable transmission media that may also participate in the provision of software, application programs, instructions and/or data to the computer module 1101 include radio or infra-red transmission channels as well as a network connection to another computer or networked device, and the Internet or Intranets including e-mail transmissions and information recorded on Websites and the like.

The second part of the application programs 1133 and the corresponding code modules mentioned above may be executed to implement one or more graphical user interfaces (GUIs) to be rendered or otherwise represented upon the display 1114. Through manipulation of typically the keyboard 1102 and the mouse 1103, a user of the computer system 1100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1117 and user voice commands input via the microphone 1180.

FIG. 1B is a detailed schematic block diagram of the processor 1105 and a “memory” 1134. The memory 1134 represents a logical aggregation of all the memory modules (including the HDD 1109 and semiconductor memory 1106) that can be accessed by the computer module 1101 in FIG. 1A.

When the computer module 1101 is initially powered up, a power-on self-test (POST) program 1150 executes. The POST program 1150 is typically stored in a ROM 1149 of the semiconductor memory 1106 of FIG. 1A. A hardware device such as the ROM 1149 storing software is sometimes referred to as firmware. The POST program 1150 examines hardware within the computer module 1101 to ensure proper functioning and typically checks the processor 1105, the memory 1134 (1109, 1106), and a basic input-output systems software (BIOS) module 1151, also typically stored in the ROM 1149, for correct operation. Once the POST program 1150 has run successfully, the BIOS 1151 activates the hard disk drive 1110 of FIG. 1A. Activation of the hard disk drive 1110 causes a bootstrap loader program 1152 that is resident on the hard disk drive 1110 to execute via the processor 1105. This loads an operating system 1153 into the RAM memory 1106, upon which the operating system 1153 commences operation. The operating system 1153 is a system level application, executable by the processor 1105, to fulfil various high level functions, including processor management, memory management, device management, storage management, software application interface, and generic user interface.

The operating system 1153 manages the memory 1134 (1109, 1106) to ensure that each process or application running on the computer module 1101 has sufficient memory in which to execute without colliding with memory allocated to another process. Furthermore, the different types of memory available in the system 1100 of FIG. 1A must be used properly so that each process can run effectively. Accordingly, the aggregated memory 1134 is not intended to illustrate how particular segments of memory are allocated (unless otherwise stated), but rather to provide a general view of the memory accessible by the computer system 1100 and how such is used.

As shown in FIG. 1B, the processor 1105 includes a number of functional modules including a control unit 1139, an arithmetic logic unit (ALU) 1140, and a local or internal memory 1148, sometimes called a cache memory. The cache memory 1148 typically includes a number of storage registers 1144-1146 in a register section. One or more internal busses 1141 functionally interconnect these functional modules. The processor 1105 typically also has one or more interfaces 1142 for communicating with external devices via the system bus 1104, using a connection 1118. The memory 1134 is coupled to the bus 1104 using a connection 1119.

The application program 1133 includes a sequence of instructions 1131 that may include conditional branch and loop instructions. The program 1133 may also include data 1132 which is used in execution of the program 1133. The instructions 1131 and the data 1132 are stored in memory locations 1128, 1129, 1130 and 1135, 1136, 1137, respectively. Depending upon the relative size of the instructions 1131 and the memory locations 1128-1130, a particular instruction may be stored in a single memory location as depicted by the instruction shown in the memory location 1130. Alternately, an instruction may be segmented into a number of parts each of which is stored in a separate memory location, as depicted by the instruction segments shown in the memory locations 1128 and 1129.

In general, the processor 1105 is given a set of instructions which are executed therein. The processor 1105 waits for a subsequent input, to which the processor 1105 reacts to by executing another set of instructions. Each input may be provided from one or more of a number of sources, including data generated by one or more of the input devices 1102, 1103, data received from an external source across one of the networks 1120, 1102, data retrieved from one of the storage devices 1106, 1109 or data retrieved from a storage medium 1125 inserted into the corresponding reader 1112, all depicted in FIG. 1A. The execution of a set of the instructions may in some cases result in output of data. Execution may also involve storing data or variables to the memory 1134.

The disclosed teaching arrangements use input variables 1154, which are stored in the memory 1134 in corresponding memory locations 1155, 1156, 1157. The teaching arrangements produce output variables 1161, which are stored in the memory 1134 in corresponding memory locations 1162, 1163, 1164. Intermediate variables 1158 may be stored in memory locations 1159, 1160, 1166 and 1167.

Referring to the processor 1105 of FIG. 1B, the registers 1144, 1145, 1146, the arithmetic logic unit (ALU) 1140, and the control unit 1139 work together to perform sequences of micro-operations needed to perform “fetch, decode, and execute” cycles for every instruction in the instruction set making up the program 1133. Each fetch, decode, and execute cycle comprises:

a fetch operation, which fetches or reads an instruction 1131 from a memory location 1128, 1129, 1130;

a decode operation in which the control unit 1139 determines which instruction has been fetched; and

an execute operation in which the control unit 1139 and/or the ALU 1140 execute the instruction.

Thereafter, a further fetch, decode, and execute cycle for the next instruction may be executed. Similarly, a store cycle may be performed by which the control unit 1139 stores or writes a value to a memory location 1132.

Each step or sub-process in the processes described herein is associated with one or more segments of the program 1133 and is performed by the register section 1144, 1145, 1147, the ALU 1140, and the control unit 1139 in the processor 1105 working together to perform the fetch, decode, and execute cycles for every instruction in the instruction set for the noted segments of the program 1133.

The methods described herein may alternatively be implemented in dedicated hardware such as one or more integrated circuits performing the functions or sub functions of those methods. Such dedicated hardware may include graphic processors, digital signal processors, or one or more microprocessors and associated memories.

According to one aspect of the disclosure, a system is provided in which, for a user in a defined classification of users, the system selects as the next Learning Activity, the Learning Activity most likely to produce the desired outcome for the user. This is achieved by the system utilising ranking algorithms to rank the next lesson options that use the recorded learning outcomes of other students with the same User Classification as the user.

A block diagram of the herein described system is shown in FIG. 1C.

Various elements of the system and methods described herein may be considered heuristic teaching and learning systems and methods.

The following describes how the system operates with a user that has already been registered with the system. The registered user logs in to Learning Interface 112 using any suitable computer device/platform, such as that described above with reference to FIGS. 1A and 1B. The Learning Interface 112 communicates 111 with a user information database in the form of a Database System 115 for logging and accessing user history.

The User History (UH) is the historical profile of the user before the user signed up to use the herein described evidence based learning system. Initially the User History Database can include the following information:
1. Age
2. Native language
3. Proficiency in native language Education Level and Qualifications
5. Residential history: <place 1, from date, to date>, <place 2, from date, to date> etc.
6. English education history: <English course description1, from date, to date>, <English course description1, from date, to date>
7. Self-assessment by user of their English language skill
8. Learning issues as disclosed by the student. For example, these may include blindness, poor vision and dyslexia
9. Equipment the user is learning on (For example, a PC, tablet, smart phone etc.)
10. Other relevant information added over time

The data received by communication 111 is used by the Learning Interface 112 to extract the User ID. The User ID is unique number assigned to each individual user which is stored in the Database System 115. The Learning Interface 112 communicates 120 the User ID to the User Classification System 116.

The User Classification System (UCS) 116 uses the User ID to query 110 the Database System 115. The User Classification System 116 receives and processes the result-set in response to query 110 and extracts the User Classification code for the specific User ID. The User Classification code is a unique combination of digits and numbers to reflect the user traits. The UCS 116 communicates 103 User Classification code to the Learning Activity Selector (LAS) 114.

The LAS 114 communicates 106 the User Classification Code to Learning Outcome Database (LOD) 117. LOD 117 runs a query based on User Classification Code to create a result-set and sends it back to LAS 114 by response 106. LAS 114 analyzes the result-set response 106 and selects the Learning Activity ID that has the highest probability of success for the User Classification Code. The Learning Activity ID is the unique number assigned to each Learning Activity inside the Learning Activity Database (LAD) 118. The LAS 114 communicates 104 the Learning Activity ID to LAD 118. The LAD 118 compiles the detail, structure, sequence and content in XML format for the Learning Activity based on Learning Activity ID it received in 104. This XML is sent in a reply 104 to LAS 114.

LAS 114 updates 106 the record associated with the User Classification Code and Learning Activity ID in LOD 117.

LAS 114 updates 107 the record in the Log File by assigning the selected Learning Activity ID against the User Classification Code and User ID in the Database 115.

LAS 114 creates a package Next Learning Activity 113 by adding User ID and User Classification Code to XML received from LAD 118.

The Next Learning Activity 113 is passed 101,102 to Learning Activity Generator (LAG) 122

LAG 122 receives and processes the Next Learning Activity 113 to create a Learning Interface 112 according to user device capabilities, platform features and screen size.

The combination of the LAG 122 and the LAS 114 form a Learning Activity Control Module 199. A Learning Activity can be adjusted based on feedback received from interaction with the user as well as other information. That is, the learning activity control module may first select and generate a learning activity. It may then control, adjust, modify, manipulate or change a learning activity after it has been selected.

At the end of the learning activity session, the Learning Interface 112 updates 111 Log File with log information generated by the user during the session. This log information includes interaction data while the user is interacting with the Learning Activity as well as the results of the Learning Activity. A new result log triggers an update 108 to add information of Skill Learned and Result in the LOD 117 against the User ID, User Classification Code and Learning Activity Code. A Skill Learned is defined as a skill taught by one or more Learning Activities. Some examples include the ability to add numbers, the ability to understand one or more words in another language or understand how to pronounce one or more syllables etc.

The Design/Create Interface (DCI) 120 will be used by teachers and expert users to create new Learning Activities in LAD 118. The DCI 120 query 105 the LOD 117 to access information regarding the User Classification Code, Skill Learned, Result and Learning Activity. The information received 105 will be used by teachers and expert users to create a new Learning Activity in a DCI 120 which is sent as an update 119 to LAD 118 to store the newly created Learning Activity with a unique ID.

A new user will initially provide information while registering for the system on the Learning Interface 112. The user information will be sent 111 to Database 115, which will create a new user and assign a new User ID and add the information to User History.

The Database 115 will pass the new User ID and User History by communicating 110 to UC 116. The UC 116 will communicate 109 with the LOD 117 to obtain User Classification records and compare it with the User History received 110 to create a new User Classification Code for that user. The User Classification Code initially follows the below pattern but is not restricted to this pattern as a new variable in User History or Log can prompt an update to this pattern.

User classification code=CCLLRRRAASSEEUID, where:

1. CC=Country code

2. LL=Native Language code

3. RRR=Region code

4. AA=Age as an integer

5. SS=Education Level

6. EE=Years studying English

7. UID=Unique User ID

It will be understood that the term User Classification Code is intended to mean at least a portion of the code as defined above. For example, the User Classification Code may be at the very least a country code CC. As a further example, the User Classification Code may include as a minimum a country code CC and a Native Language Code LL, forming a code CCLL. As a further example, the User Classification Code may include as a minimum a country code CC, a Native Language Code LL and a Region code RRR forming a code CCLLRRR. As a further example, the User Classification Code may include as a minimum a country code CC, a Native Language Code LL, a Region code RRR and an Age as an integer forming a code CCLLRRRAA. As a further example, the User Classification Code may include as a minimum a country code CC, a Native Language Code LL, a Region code RRR, an Age as an integer and an Education level forming a code CCLLRRRAASS. As a further example, the User Classification Code may include as a minimum a country code CC, a Native Language Code LL, a Region code RRR, an Age as an integer, an Education level and Years studying English forming a code CCLLRRRAASSEE. It will be understood that any of the code elements 1 through to 6 listed above, or any combination thereof, may be used as a User Classification Code that is not unique to a particular user. The addition of the 7^{th} element results in a User Classification Code that is both assigned to a particular user and also easily searchable and comparable to other users of the system.

The new User Classification Code is sent 109 back to LOD 117 for creating a new record.

The UC 116 communicates 103 User ID and User Classification code to LAS 114.

The LAS 114 uses the User Classification Code to query 106 the LOD 117. The LOD 117 will return 106 the result showing that it is a new User Classification with no results for next activity selection. In this case LAS 114 will communicate 104 with the LAD 118 to select the default Initial Student Quiz.

The LAD 118 compiles the detail, structure, sequence and content in XML format for the Initial Student Quiz. This XML is sent in a reply 104 to LAS 114.

LAS 114 updates 106 the record by associating the user's unique User Classification Code with the Initial Student Quiz in LOD 117.

LAS 114 updates 107 the record in the Log File by assigning the Initial Student Quiz to the user's User Classification Code and the User ID in the Database 115.

LAS 114 creates a package Next Learning Activity 113 by adding User ID and User Classification Code to XML received from LAD 118.

The Next Learning Activity 113 is passed 101,102 to Learning Activity Generator (LAG) 122

LAG 122 receives and processes the Next Learning Activity 113 to create a Learning Interface 112 according to user device capabilities, platform features and screen size.

At the end of the Learning Activity session the Learning Interface 112 updates 111 Log File with log information generated by the user during the session. This log information includes the user interaction data and the results of the user interacting with the Initial Student Quiz. A new result log in Database 115 will invoke UC 116 by communicating 110 the User ID and Result for the User Classification Improvement Process.

### Difference Between User ID and User Classification Code

The unique User ID is attached to every user and enables the system to track the user on individual basis throughout the system. One example of this is the case where the User ID is used when individual customization and modification of the Learning Activities is required.

The User Classification Code as per the format described above is unique to user as well but allows the search of the database on any of its constituent codes. For example:

1. A search query based on the CC

2. S search query based on CC where LL=“English” and AA=“9”

FIG. 2 shows a User Classification System which may be invoked on demand or triggered by a specific event in the other sub systems. For example, the specific event may be a machine learning system determining that a significant number of students in the same User Classification have good results from a particular Learning Activity, and a significant number fail and then raising a flag accordingly. It will be understood that this may result in a User Classification that is separated into two User Classifications with a first used to classify students that are doing well and a second to classify students that are failing.

If the User Classification System is invoked manually the module 201 will query 205 the Database 115 to look for new variables in the Log File and User History.

These new variables are sent back 205 to module 201. The module 201 runs a query 206 on the LOD 117 for each variable to get results and Skills Learned data.

The returned data associated with the Results and Skills Learned query against the variable is sent to Module 202 which decides if the variable is statistically important, for example, if the variable has a major impact on the Skills attained by the user or User Classification Code.

If the variable is statistically important, a new User Classification Code is created and stored 208 in the LOD 117. LOD 117 communicates 108 with the Database 115 to populate User ID and Learning Activity against the newly created User Classification Code.

If the variable is NOT statistically important, the module 203 ignores this combination and passes the control back to module 201.

The loop between modules 201, 202 and 203 continues until all the new variables and combination of these variables has expired.

Referring to FIG. 3, the Design/Create Interface 120 can be accessed by the following types of user:

1—Administrator

2—Researcher

3—Authorized teacher

4—Student

### Scenario 1: Modify and Update an Existing Learning Activity

The user can select Learning Activities from LAD 118 by communication 119 and the system presents the user with a WYSIWYG (What You See Is What You Get) interface to customize and modify the learning activity. After the modification and updates are complete in the DCI 120, the DCI 120 creates a new version of the Learning Activity by linking it to the User ID and User Classification Code and stores 119 it back in the LAD 118.

### Scenario 2: Create and Design a New Learning Activity

The user can also create a new Learning Activity in the DCI 120. To do this DCI 120 communicates 105 with the LOD 117 to obtain the Learning Activity IDs, which result in better results for User Classification Code. LOD 117 also communicates 108 with Database Systems 115 to obtain User History for the classification code. This information is then passed 105 back to DCI 120. This information allows the user to create a brand new activity from scratch or combine the features and content of useful Learning Activities to create a new Learning Activity and link it to the User Classification Code and store 119 it into the LAD 118.

Referring to FIG. 4, the Learning Activity Selector LAS 114 is invoked by User Classification System UCS 116 by communicating 103 the User Classification Code.

The LAS Module 405 communicates 105 with the LODB 117 to get results and Skill Learned against the User Classification Code. The LAS Module 405 analyzes the results and Skill Learned and determines if revision is required or teaching of new content is required.

The following factors may determine the course of action taken by the LAS Module, however it will be understood that there may be a number of other factors taken into account:
1. The results of the last Learning Activity successfully completed by the user. If the results are good results (70-100%) then the system determines that is time to teach the user new content. If the results are categorized as a “fail” then the system determines it is time to for the user to revise the basic skills required to achieve a better score.
2. The system determines that a certain amount of time has been passed for the Skill Learned in previous activities without any further or significant progress.
3. An incident in a log can also prompt the system to start a revision activity. For example, a user may click on a syllable to invoke help, where that syllable is known to be a problem for that user. This means the user may not be confident in reading or saying that particular syllable and therefore requires a revision activity.

### Teaching Scenario

The LAS Module 401 communicates 106 the User Classification Code to the Learning Outcome Database (LOD) 117. LOD 117 runs the query based on User Classification Code to create a result-set and sends it back to LAS 114 by response 106. LAS Module 401 analyzes the result-set response 106 and selects the Learning Activity ID that has the highest probability of success for the User Classification Code as follows:

The following information is extracted from the result set by the LAS Module 401.

1. Learning Activity ID

2. Number of users using that Learning Activity with a good result (g)

3. Number of users using that Learning Activity with a pass result (p)

4. Number of users using that Learning Activity with a fail result (f)

The LAS Module 401 then applies a ranking algorithm to the result of the query to create a result rank (RR) and chooses or selects the Learning Activity with the highest rank. An example of a result ranking algorithm is RR=2g+p−f

Once the Learning Activity ID is selected by the above algorithm. The LAS Module 401 communicates with Module 403. The Module 403 communicates 104 with the LADB 118 to receive content for the Learning Activity. The LAD 118 compiles the detail, structure, sequence and content in XML format for the Learning Activity based on the Learning Activity ID and sends it back to the LAS Module 401.

LAS updates 106 the record for the User Classification Code and the Learning Activity ID in LOD 117.

LAS updates 107 the record in the Log File by assigning the Learning Activity ID to the User Classification Code and the User ID in the Database 115.

LAS creates a package Next Learning Activity 113 by adding User ID and User Classification Code to XML received from the LAD 118.

The Next Learning Activity package 113 is then created in a similar manner.

### Revision Scenario

The LAS Module 402 communicates 106 the User Classification Code to Learning Outcome Database (LOD) 117. LOD 117 runs the query based on User Classification Code to create a result-set and sends it back to the LAS 114 in response 106. LAS Module 402 analyzes the result-set response 106 and selects the Learning Activity ID for revision.

Once the Learning Activity ID has been selected as a revision activity. The LAS Module 402 communicates with the Module 403. The Module 403 communicates 104 with the LADB 118 to receive content for the Learning Activity. The LAD 118 compiles the detail, structure, sequence and content in XML format for the Learning Activity based on the Learning Activity ID and sends it back to the LAS Module 402.

LAS Module 402 communicates with LAS Module 404 to set up the revision schedule. The LAS 404 will communicate 107 with the Database 115 to access the Log File and find the usage revision pattern, such as, for example:

1—Number of Session

2—Timing of sessions

3—Duration of sessions

Using the above information, the LAS Module 404 creates the revision schedule.

LAS updates 106 the record for the User Classification Code and the Learning Activity ID in LOD 117.

LAS updates 107 the record in the Log File by assigning the Learning Activity ID to the User Classification Code and the User ID in the Database 115.

LAS creates a package Next Learning Activity 113 by adding the User ID and the User Classification Code to XML received from LAD 118.

The Next Learning Activity package 113 is then created in the same manner.

The revision schedule can be overridden by the user in the Learning Interface 112 and this customization step will then be saved in the Database 115.

### Initial Student Quiz (ISQ)

The Initial Student Quiz is for new users and tests a student's basic knowledge of the subject that the student is starting to learn before they commence Learning Activities. The ISQ is used by the User Classification System to improve the User Classification which is initially based on the User History only.

The ISQ for a language subject could be a vocabulary, grammar and/or reading test to enable assumptions about the knowledge of a particular user to be tested.

Student Language Knowledge Database (SLKD) for each student contains the phonemes, syllables and words of the language the Learning Activities are being taught in. Every time a student learns a phoneme, syllable or word, this is recorded by the system in the SLKD. The SLKD records for each word the user's skill or knowledge relating to the decoding of the written word, sightword recognition of the word, ability to hear the spoken word (auditory discrimination), ability to accurately pronounce the word, knowledge of the parts of speech (needed for using the word in communication), and the meaning of the word.

The vocabulary of students is estimated by the system using the following rules:

The system assumes that Native English speakers know the phonemes and the first 2000 words of their native language. When a native English speaker undertakes the Initial Student Quiz (ISQ), the system selects and generates a Learning Activity for the native English student to interact with which will quiz the student on the meaning of say the 3000th word in the Dictionary, the 3500th, the 4000th and so on. If the system determines from the students interaction with the user interface that mistakes in the learning activity are repeated, the student will be assumed by the system to know words in the list before the mistakes started.

The vocabulary of Non Native English speakers will be estimated from the User Classification, and is based on the vocabulary other students with the same User Classification have been measured to know. Non native English speakers will be tested for auditory discrimination and pronunciation skills, knowledge of phonemic awareness, grammar rules and vocabulary by playing games and undertaking exercises.
1. When a student signs on for a new Learning Pattern or Learning Activity using the Learning Interface, the learning Activity Database writes all words contained in Learning Units into the Student's SLKD that are not in the student's SLKD.
2. When a student interacts with the system using the Learning Interface, and encounters a new word, the student can highlight the new word and click on the favorites button in the Learning Interface, and the learning Interface will write that new word to the student's SLKD.

A similar process is undertaken by the system by outputting learning activities that test for knowledge of grammar rules and reading skill.

The User Classification Language Knowledge Database (UCLKD) is a database with the same structure as the SLDK and generated by the system from the entries of the SLDK's for each student in a particular User Classification according to a rule. An example of such a rule is that an entry must appear in 70% of the SLDK's of students in that User Classification for the entry to be included in the UCLKD. It will be understood that the percentage value may be more or less than 70%, such as 60% or 80% or a percentage point in-between or the system may utilize any other suitable estimation rule.

Logging system (Logsys) captures all information relating to how the user interacts (user interaction data) with the system in as much granularity as possible and either uniquely tags each data element in XML and/or writes the information in as much granularity as possible into the Log File database, which is stored on a server, either in real time or after each session logout by the user. If the user is off line, the log data is tagged in XML and whenever the user is again online, the log data is added to the Log File database. Code to capture user interaction data is embedded in every Learning Tool, and therefore in every Learning Activity so that every interaction that the user has with the system via the learning interface is captured and logged.

The database storing the Log File is a non-relational database and allows logged data in a large variety of formats to be uploaded and stored in the database without restricting the search functionality to simultaneously query different data formats and datasets.

The date and time that data is written to the Log File is recorded and no data is deleted or over-written. If information such as the User Classification changes, then the most recent entry is used on an ongoing basis but retaining the older data will enable the older data to be accurately analyzed.

Sampling for audio is done in milliseconds, for example, and for mouse movements in done in 10 millisecond samples, for example.

Queries made on the Log File database can generate specific reports that can be imported into statistical tools and into a machine learning system for analysis.

The query can map many different data fields into a small number of fields effectively reducing the number of variables that will be processed by the statistical or machine learning systems.

The User Classification (UC) 116 groups students who learn in similar ways by analyzing information in the Log File and User History. User Classifications have a number of variables. Each variable has a number of allowed values. The number of User Classifications is determined by the user classification module by multiplying the number of allowed values for each variable. For example, assume that there are 3 variables, and that variable 1 has 2 allowed values, variable 2 have 3 allowed values and variable 4 has 4 allowed variables. There will be 2×3×4=24 possible User Classifications.

Storing the Log File data in a database allows the database to output data in the allowed values by executing an appropriate query. For example, if the outcome scores for Learning Activities are a variable in a User Classification, and the outcome scores are recorded and logged in the range 0-100, the outcome scores may be mapped to just 3 allowed values—

1. Allowed value 1 (fail) for the range 0-49

2. Allowed value 1 (pass) for the range 50-69

3. Allowed value 1 (good) for the range 70-100

The initial User Classifications may be set manually. The initial User Classifications should all have users in the classifications: if there are no users or a very small number of users, the variable or the allowed value should be reexamined.

Each User Classification may have a unique number. The definition of the User Classifications—the variables and the defined values of each variable, are stored in the Log File. The User Classification Module 116 determines and writes a User Classification of each user to the Log File with a start date. If a User Classification changes, then the new User Classification is written with a start date, but the previous User Classification and its start date is still retained on the log file to enable historical research.

Learning Outcomes Database (LOD) 117 uses the logged results of already completed Learning Activities to allocate a new Learning Activity with the highest probability of producing the best outcomes for a user with a particular User Classification. Initially when there is little data, the Learning Outcomes Database should have a limited number of variables.

The LOD is created by querying the log file and extracting the data for each Learning Activity completed by each user.

The LOD database records may include at least:

1. User classification number

2. Learning Skill number

3. Learning Activity Class number

4. Three outcome variables: good, pass, fail

5. User id

Learning Activity Database (LAD) 118 stores Learning Activities and components of Learning Activities such as Learning Units and Learning Tools. The following features allow for the location and retrieval of Learning Activities
1. Stores the Learning Activities, Learning Units and Learning Tools
2. Users can upload and save Learning Units to the learning Activity database
3. Each Learning Activity, Tool and Unit can be tagged by Skill taught by the Learning Activity
4. Allows Learning Activity, Tool and Unit to be searched by content including:
   a. Text within the Learning Activity, Tool and Unit is searchable
   b. LA, LT and LU can be tagged with keywords that can be used for searching
   c. LU, LT and LU can be tagged with Curriculum information—which curriculum is this information used in and what LU's are included in a particular curriculum
5. Allows each Learning Activity, LT and LU to be tagged with metadata including
   a. Description of the content of the LA, LT and LU
   b. Ownership of the LA, LT and LU
   c. Rights to view and use the LA, LT and LU. Users can restrict the right to view content to themselves, a defined group (such as students at a school, students in a particular class, employees of a company), a User Classification or other definition of the allowed users
   d. Royalties payable for using the LA, LT and LU

Multimedia Repository is part of the Learning Activity Database and holds all the multimedia content generated by Teachers and experts to be used in the Learning Activities. It also holds all the multimedia content generated by the users of the system, labeled for future access to depict progress and conduct research.

Learning Activity Design/Create Interface 120. This interface allows a user to design, create, modify and customize Learning Activities using a graphical interface. The Learning Tools are selected in the order they will be displayed. The timing of the display is determined by the position on a timeline of an icon representing the Tool. The position of the Learning Tools is determined by the location and size of the Tool display on the designer's screen. Settings within each Tool are stored in the learning Activity. The Learning Units to be displayed in the Learning Tool are dragged and dropped onto the Tool in the order they are dragged and dropped. Users can locate the Learning Activities, Learning Tools and Learning Units by searching the Learning Activity database via the Learning Interface as described above.

Learning Tools will also include tools that will capture and display user data. An example is that a user can record and play back sounds, e.g. in the pronunciation tool as described herein. A second example is that a user can record videos of the user pronouncing phonemes, syllables, words, sentences etc. and displaying this next to a window that displays the a person filmed making the correct pronunciation. The tools will allow a user a number of tagging and playback features that will enable the user to locate and tag parts of the recordings that are of interest to them, and play them back in ways best suited to the user. An example of the play back to help users learn is playing back the recording of the user and the person making the correct pronunciation multiple times in the order, and with the timing, chosen by the user.

Learning Activities, Learning Patterns and Lessons can be

1. created manually using the Learning Pattern Creation Module

2. created by adding new Learning Units to an existing Learning Activity.

3. modified manually using the Learning Pattern Creation Module

4. modified by using the user customizing interface

The people with access to create or modify learning Patterns of Lessons include:
1. An administrator.
2. A researcher setting up a test in the Research System testing two different Learning Patterns (Patterns A and B which can be new patterns created or modified by the researcher) by selecting a number of users with the same User Classification and having half using Pattern A and half using Pattern B and statistically comparing the results.
3. An authorized teacher developing a new Learning Pattern using the Lesson Creation Module or customizing learning patterns (either using the Lesson Creation Module or customizing an interface) or by adding their own teaching material.
4. A student using the customization interface.

### Skills Prerequisite Database

It is important that skills are taught in the right order. For example, a student needs to understand multiplication, addition, subtraction and division before they can learn algebra. This database lists out for any skill, what the prerequisites for that skill are so that a student is not taught something that they do not have the prerequisite skills for.

The Skills Prerequisite Database, which may form part of the database 115 or part of any other database connected to the system, consists of a skill and a list of prerequisite skills. Each skill is numbered. Assume Algebra skill is skill 27, addition is skill 3, addition is skill 4, multiplication is skill 5, and division is skill 6. The entry in the database would be 27 P(3, 4, 5, 6). Adding skills and prerequisite skills in managed through the Skills Database Interface, which may form part of the learning interface 112 or be formed as a separate interface.

The Design Interface Module is arranged to query the Skills Prerequisite Database to determine whether the order of Learning Activities in a Learning Pattern enables the user to have the prerequisite skills to complete those learning activities in that particular patter. Upon determining that the pattern will provide a learning activity which the user would not (or does not) have the prerequisite skill, the design interface will output an error message to the designer of the Learning Pattern. For example, if the learning Activities are in the wrong order an error message will be displayed.

Customization System allows a user to edit and redesign the interface for the Learning Activity. These changes are applied on the interface and stored in the database. This data can be used by the Optimization system to pre-select the Learning Pattern for new and similar users. The Customization System also allows a user to select different accents for phonemes, syllables and words stored in the Language Dictionary for those Learning Tools which have audio playback facilities.

FIG. 11 shows a process for designing a new Learning Activity using the Design/Create Interface 120 as shown in FIG. 1C and FIG. 3. The process starts by the user selecting the option to start the design. The user then selects a component from a list of displayed components and drags the component from the list to a timeline. The user then edits the properties of that component via a properties dialog displayed on the interface. If the user has completed the design, the design is updated and stored in the database.

If the design is not complete, the user can set priming settings for the Learning Activity. This is performed by the user selecting specific priming options, such as the time an image is to be displayed, for example. The design is then updated and stored in the database.

Once the priming settings are completed, the user can adjust the timing of the various learning units forming the Learning Activity by dragging and dropping the elements to a selected position on the timeline.

The user continues this process for each of the components (Learning Units) of the Learning Activity.

FIG. 12 shows a process for customizing Learning Tools, Learning Activities and Learning Patterns within the User Interface after the User Interface has been loaded. The user adjusts component features of a Learning Activity based on their personal preferences and the capabilities of the computing device upon which they are operating the learning system. For example, the user may adjust one or more of time, order, position, size and visibility of various elements, components, icons or Learning Units of the Learning Activity. Further, the user may adjust the content displayed within a component, such as multiple definitions for example. The format of the content displayed within the Learning Activity may be adjusted, such as the font, size and color of elements being displayed.

Once completed, this learning pattern is updated and stored in the database against the user profile.

The system may then obtain the media associated with the Learning Activity from a media repository and render the learning user interface. The media and interface are then rendered and displayed on the screen of the user's computing device.

FIG. 13 shows a process for Learning Activity playback in the user Interface. According to this example, FIG. 13 describes the playback of a Learning Activity in the Vocabulary Building tool.

The process starts with the user clicking the playback button 1002 (as shown in FIG. 10). The first “word” in the vocabulary set is selected. The first component on the timeline (802 in FIG. 8) is selected and initialized to display its content on the user's computing device. For example, the system displays “word” on the screen. At this initialization point the priming occurs, if available and enabled for this component. Once the priming is rendered on the user device, the control is passed back and the main content is displayed.

After the display of the main content, the process waits for the specified amount of time (interval between components). The process then moves to display the next component in the sequence. In the case where it is the last component for that specific “word”, the process is repeated for the next word in the vocabulary set, and the process is repeated as above.

If it is the last word in the vocabulary set, the process moves to display the exercise component, which can be a quiz, a matching game etc.

The results of the exercise are displayed and logged in the database. The playback then ends.

Learning Activity Selector (LAS) 104 selects the Learning Activity that has the highest probability of success for a user with a particular User Classification and schedules the new learning (and revision) activities.

The Learning Activity Selector queries the Learning Outcomes database for a user with a particular user classification to wanting to learn a particular skill to retrieve the following output from the database:
5. Learning activity number.
6. Number of users using that Learning Activity with a good result (g).
7. Number of users using that Learning Activity with a pass result (p).
8. Number of users using that Learning Activity with a fail result (f).

The LAS then applies a ranking algorithm to the result of the query to create a result rank (RR) and choosing the Learning Activity with the highest rank. An example of a result ranking algorithm is:

RR=2g+p−f

Improving User Classification

As referenced in the discussion of FIG. 2, in order to be able to conduct experiments with statistically significant results, in the early stages, when there is little data, only a small number of User Classifications can be accommodated. As more data is collected, more variables, and more allowed values of the variables, can be added to the User Classification definitions, generating more User Classifications, by changing the Log File query to output data containing the additional variables or allowed values. Adding more variables and allowed values can improve the accuracy of the outcome rankings. The User Classification Improvement process works to systematically add new User Classifications that will improve the outcomes of the users in the new User Classifications.

For example, if there is a Learning Activity where a significant proportion of the students have good results and the others fail, then it is likely that the users can be reclassified so that the group who have a good result are in one classification and the group that failed are in a different classification.

Assume that the initial user classification is based on 4 variables known to affect learning outcomes:

1. Age range.

2. Education level in native language.

3. Years studying English.

4. Native language.

Further assume that:
1. when users in a particular User Classification are learning with a particular Learning Activity, a number of the students do well and the rest fail.
2. variable 9 in the User History, the type of equipment, is added to the User Classification variables and the Learning Outcomes Database is regenerated from the Log File and User History with the 5, not 4, variables.
3. all of the users using PC's (i.e. large screens) do well, and that students with smart phones (small screens) fail.

Adding the additional variable will split the User Classification into users with large screen and users with small screens and will make the prediction more accurate as to whether the users will succeed or fail. So the User Classification variables should be extended to include variable 9, and two new User Classifications should be created and the new definitions of the User Classification recorded in the Log File.

### Machine Learning Systems

Machine Learning Systems (MLS) are software and hardware systems that use algorithms to learn functions from exposure to data. Data from one or more databases described herein is input into the MLS in the form of data records, which may consist of various data type such as text, real-valued and complex numbers, vectors or even raw bit-sequences.

One standard machine learning technique is to use algorithms, both learning and non-learning, to extract features, which are then classified. Features may come in a variety of forms, including discrete numbers or events and/or number vectors. An example of feature encoding is to take scores in a test ranging from 0-100 and mapping these 101 values into 3—0-15 is allowed value 1 (fail), 50-70 is allowed value 2 (pass) and 71-100 is allowed value 3 (good). In such an example the features exist in a lower dimensional discrete space (3) than the input data (100). However, features may also exist in a higher dimensional space than the input data, particularly if the input data is non-linearly separable. The choice of feature representation is critical to MLS performance and can vary from problem to problem.

MLS can be set up in 3 modes: supervised, semi-supervised and unsupervised. In the supervised case the MLS is given the desired input-output mappings, while in the unsupervised case it is not. Semi-supervised MLS combine elements of both, for example through unsupervised feature learning and supervised classification or through initial supervised learning and further unsupervised “fine tuning”.

The raw data is feature encoded (e.g. mapping the raw data to a set of specific variables with allowed values) and fed into the MLS, which learns desired input-output mapping through modification of internal variables. The MLS can model input-output relationships with greater certainty as the number of data records or internal capacity is increased. Accurate data records are required for the calculation of accurate statistical relationships, although some MLS can handle modest amounts of noise and mislabeled training data.

Using the learned model developed by processing the data records, the MLS can be used for a number of processes including optimizing a system for a particular outcome, prediction based on analysis of past events, and classifying similar data units into groups.

A number of vendors, such as IBM, supply MLS. Service vendors such as Amazon Web Services provide integrated Cloud based MLS services.

In the initial implementation of machine learning to assist optimization, there will be limited amounts of data available. As a result, the data will be strongly feature encoded to reduce the complexity of the data and the number of variables. As described in the User Classification section, it is possible to execute appropriate database queries to map a large number of values to a small number of allowed values. This mapping of values is equivalent to the term “feature encoding” used in machine learning algorithms. The mapped user data will be contained in numerical vectors such as (n1, n2, n3, . . . ), where n1, n2 etc. have a limited number of allowed values.

So in the user Classification example above, the element in the vector relating to outcome would have 3 allowed values: 1. 2 or 3.

Machine learning systems can produce different kinds of results based on the amount of data that can be analyzed, the format in which the data is submitted and the way the machine learning system is set up. The types of patterns that machine learning algorithms can find include
1. Learning Patterns that produce the optimal output for a single variable, such as given User Classification, if there is limited data, and
2. if there is sufficient data, Machine Learning algorithms can also optimize multiple variables at the same time, such as User Classification and results, creating new User Classifications defined by multiple variables, and linking these new User Classifications to create new Learning Patterns that produce good results for users in the new User Classifications.

### Curriculum Database

The Curriculum Database defines particular learning goals, which can be skills or facts (Learning Units and a combination of both) that need to be learned for a particular course.

The Learning Units in a curriculum can be specified individually with high granularity such as a list of words to be learned for a spelling text, or a list of words and their meaning that need to be learned so that a user can make sense of a document that uses these words.

Alternatively, the Curriculum can be specified more broadly, such as a direction in a hospitality course to “learn the vocabulary of a hotel room and bathroom”.

A curriculum may be written in multiple parts, specify some parts in high detail and other parts generally.

Teachers developing courses based on a particular curriculum can save considerable time by using the Learning Activity Database to generate a report that lists.
1. Learning Activities that purport to teach to the curriculum in question or in similar curricula, and
2. Learning Units that have been included in the Learning Activities for the curriculum in question or in similar curricula.

A combined query of both the Log File and the Curriculum Database will inform teachers what in the curriculum has been learned and what is remaining to be learned by students they are teaching. The query operates by taking each Learning Unit and Skill in the Curriculum database for a particular source and accessing the Log File of the users in the course to see if the Learning Unit or Skill has been taught and what the learning outcomes of the teaching were.

The Administration module allows schools to set up teachers and teachers to set up students, providing user names and passwords, and administration reports to be generated.

Teacher Reports Module allows teachers to generate reports based on querying the Log File, the SKD and the Curriculum Database.

Royalty Module allows system to calculate which user need to pay what royalties to which owner of Learning Units or Learning Activities.

Benefits of the First Aspect of the Disclosure

A large amount of teacher time is currently spent on classroom administration that can be automated with the system. In the new system, teachers and parents can access reports that show what students are learning, how long they are spending, when they are studying, and how successful they are at studying. Students can learn at their own pace and in their own time.

In schools where the ways students are taught are individualized for each student, the management overheads of managing individual student work plans are substantial. The amount of effort required increased dramatically as learning activities get shorter, with some educators calculating that learning activities—learning information and interacting with the information, such as with a multiple choice test—should take no more than 10 minutes, or student concentration is likely to fall off. The work load in manually managing 6 ten minute lessons for each of 20 students in a one hour class seems unachievable for any teacher. The herein described system manages this allocation of the learning activity intelligently and gets better at it as more data is collected.

Teachers will no longer be looking for the “best textbook”. Instead the focus will be on what does a student in that user classification needs to study next.

A Second Aspect of the Disclosure

A Second Aspect of the Disclosure is as a Research System that enables researchers to efficiently study user interaction data collected in the Log File and User History Database 115 to develop hypotheses, to test these hypotheses by querying the Log File and User History, to incrementally improve understanding by expanding the range of variables and the allowed values of these variables as the data volumes allow, and user numbers increase, use the system to conduct large multivariable scientific experiments quickly and efficiently.

The features of the Research System include:
1. The system can potentially generate enormous quantities of accurate, accurately tagged and highly granular data in the Log File and the User History. This information is retained and archived and is not modified.
2. The ability of teachers to import their own materials and generate their own Learning Activities either from scratch or by modifying an existing Learning Activity, and the ability of students to customize their own interfaces, will see crowd-sourced improvements to Learning Activities that may generate significant improvements to learning outcomes. All Learning Activities modifications are tracked.
3. The User Classification and the Learning Outcomes Database are ways that the system can intelligently classify the Log File and User History database and make the data more understandable for researchers. For example, the Learning Outcomes Database might report that the most efficient Learning Activity for Chinese speakers to develop auditory discrimination in English is a Learning Activity in which audio files are played of phonemes and syllables recorded in a Chinese accent. This information may suggest to new modifications to Learning Activities to test hypotheses about best way to teach Chinese students auditory discrimination of English phonemes, syllables and words.
4. The system has been set up via the Learning Outcomes database to track improved learning outcomes resulting from modifications to Learning Patterns and Learning Activities. This tracking of improved learning outcomes is likely to stimulate researchers into developing new hypotheses to be tested.
5. If there is sufficient data, researchers can quickly and easily conduct virtual experiments. For the purpose of the experiment, researchers can change the User Classification by changing the definitions of the User Classification. The researcher can do this by changing the queries on the Log File and User History 115. New User classifications will in turn change the Learning Outcomes database and produce new Learning Outcomes for the new User Classifications. Learning Outcomes for the original and the new User Classifications can be statistically compared by submitting the both sets of results to a statistical package.
6. As the volume of data increases, machine learning systems can be used to look for relationships in the data using queries executed on the Log File and User History database to export the information in the Log File and User History in an appropriate vector file. Usually these vectors will incorporate relationships that have already been established by including the variables and allowed variable values that define these established relationships.

Using the System to Locate Possible Treatments or Interventions.

A number of students, such as those with autism, have issues that are difficult to find successful interventions, or treatments, that will assist the student to overcome or ameliorate their difficulties. All student interactions with the system are logged. A query on the Log File and User History 115 will enable the results of Learning Activities for students with a diagnosed and disclosed condition such as autism to be extracted from the log file and outputted to a file, sorted in order of outcome. By examining this output file, researchers are able to see what Learning Activities might be an effective intervention for the types of difficulty they are interested in treating.

If distinctive usage patterns for users with particular issues are found by querying the Learning Outcomes Database, then the log files of all users will be examined to see if these distinctive patterns are found in other diagnosed users, and also to see if other users have these patterns, and if they do, which other users have these patterns. If other users do have these patterns, then the users with these patterns will be examined by a professional to see whether they do in fact have the same issues as the people with the diagnosed issues.

Over time, as sufficient data is collected, statistically significant tests may be able to be developed. By looking at what Lesson Plans worked best for the students with the diagnosis, the same lesson Plans can be suggested to new students who fit the same diagnostic pattern.

In the meantime, the list of possible interventions may be of great assistance to some parents, teachers and specialists in developing interventions for particular students.

If there is not sufficient data in the Log File and User History 115, a researcher can set up and run new experiments to collect the data to test the hypothesis as set out below.

Students participating the tests can be recruited quickly, they will already be using the system and will need little training. The testing may be done online, thus removing the need for premises. In many cases, the scoring of the tests can be done automatically. Data from the test may be output in the appropriate format by executing a query of the Log File and User History database 115. This will make it possible to cost effectively conduct larger tests.

A query on the Log File and User History 115 will allow the researcher to locate users with the appropriate profile for the research. For example, the researcher may wish to test a particular way of teaching people with dyslexia and will select people who have indicated in the User History that they are dyslexic.

The researcher will set up two tests, Test A and test B and students. These tests will be Learning Activities and can be created or modified using the Design/Create Interface 120.

Students with the appropriate profile will be assigned to test A and test B. This can be done randomly by assigning a random number to each student with the appropriate who is to participate in the experiment, and then having the students whose random number ends in an even number be assigned to Test A and the rest are assigned to Test B. The results of the tests are logged in the Log File.

The researcher can write a query on the Log File to extract the results information in a format that can be submitted to either a statistical analysis package like SPSS or be input into a machine learning algorithm to determine if the test results are statistically significant. If the results are not statistically significant, the researcher may do another iteration of the test, increasing the number of test participants, or changing test A or test B.

A pilot test should enable the researcher to estimate the number of users needed to generate sufficient data to make the results statistically significant.

The procedure using test A and Test B is called an A/B Test.

Many of the learning systems being studied are complex, multivariable systems. Researchers conducting tests manually often change just one variable at a time, this is because changing one variable at a time limits the number of test participants required, and limits the complexity of the experimental design. However, it is difficult to understand a complex multivariable system when limited by technology to experiments that allow the researcher to change one variable at a time.

By using the new research system, researchers can conduct larger tests, and by using machine learning analysis, researchers will no longer be restricted to conducting experiments that change just one variable. This will enable an increase in the understanding of the mechanisms of how student learn based on analysis of empirical information. Because the tests have been developed using the system tools and system functionality, this improved understanding can be simply applied to the learning activities and systems to improve learning outcomes.

A Third Aspect of the Disclosure

A Third Aspect of the Disclosure allows the system to optimize the selection of Learning Activities for a particular student based on both the User Classification and on the personal information relating to the student in the User History and the Log File.

The benefits of this approach is that the system can:
1. Focus on teaching what the student needs to be taught about a subject.
2. Teach the student using methods and content that have been empirically shown to be efficient for students with the same User Classification learning the same content, and modify these methods and content based on the actual performance of the student that is logged, and
3. Split revision from teaching and systematically develop an efficient revision plan for the particular student to ensure that materials that have been learned while using the system (and therefore logged) are revised at the appropriate intervals and in the appropriate manner so that the revised materials are properly stored in long term memory and can be recalled at will with as few repetitions as possible. It makes little sense for students to be taught something if they then proceed to quickly forget what they have been taught.

The Student Knowledge Database (SKD) is a database of Learning Units that an individual student
1. needs to know, which is determined by the system looking at the Learning Pattern (a group of Learning Activities) that a student is undertaking and querying the Learning Activity Database to list all the Learning Units in that Learning Activity. The system imports the Learning Units that the student needs to learn into the SKD;
2. knows because the system has logged prior interactions with Learning Activities that the student has already learned;
3. is deemed to know because the system determines that students with the same User Classification know these Learning Units. The SKD is generated by querying the Learning Activity Database, the User Classification and the Log File and is held in a separate database for efficiency reasons.

Learning Unit and Learning Activity Selection by Text Content

For each Learning Unit that contains text, the system creates a Learning Unit Text Profile that is stored in the Learning Activity Database and includes:
1. Word Count
2. List of words in alphabetical order, and their frequency in the Learning Unit
3. The frequency of the words in the Learning Unit in common English usage (accessed from the Dictionary Database)
4. Average Word Length
5. Words per Paragraph
6. Sentences per paragraph
7. Average Sentence Length

One way the system can select between two Learning Units that contain text is to creating a Learning Unit Text Profile comparing the list of words in each of the two Learning Units to the list of words in the SLKD known by a particular student and choosing the Learning Unit with the fewest number of unknown words.

Similarly, a Learning Unit can be rejected because it contains words that have been tagged in the dictionary as inappropriate for that User Classification.

The User Classification Knowledge Database (UCKD) is an estimate of the Learning Units will know based and is estimated by the system according to rules from the contents of the Student Knowledge Database SDK entries of each of the members of the User Classification. An example of a rule is that the Learning Unit will be included in the UCKD if it appears in 70% of the individual SKD's. It will be understood that the 70% value may be adjusted to a higher or lower percentage or the system may utilize any other suitable estimation rule.

A Learning Unit can be selected for a particular User Classification based on the content of the Learning Unit as described in the individual case.

Teaching and Revision

Teaching related to new knowledge. Storing information permanently in long term memory requires repetition. Without sufficient repetition, memories will fade. Revision is a repetitive process that allows new information to be stored permanently in long term memory and retrieved rapidly when needed.

Revision Module

The revision module takes revises Learning Units that the system has logged that student has learned and uses these Learning Units to populate revision exercises that the student will undertake at defined intervals in the future. The initial revision plan is based on those exercises that provided the best outcomes when the student was learning the information and on revision patterns based on the timing of revision exercises that were most successful for other students with the same User Classification. The student will be given two revision patterns in an A/B Test format to see which of the test patterns, if any, produces the best result. If pattern A produces a statistically better test result than pattern B, then A and a variant of A will then be tested as a second A/B Test, and so on.

For example, a student plays a game where the student matches 100 words with their definitions correctly twice and is therefore deemed to know the words. These 100 words are entered into the revision schedule and 50 words are revised every 3 weeks (Test A) and 50 words are revised every 6 weeks (Test B). The test period for both tests is set for a determined time, in this case for 24 weeks. After 24 weeks, the student has been able to accurately recall all 50 words revised every 3 weeks but only 30 of the words revised every 6 weeks. Test A is rejected by the system in favor of Test B. So Test A continues and a new Test B1 is created by reducing the revision time by one week, so in this case teaching the words every 5 weeks. A new list of 100 new words is then used to compare Test A and Test B1 with the results that the student has statistically better results with Test A than Test B1.

A Fourth Aspect of the Disclosure

Language is a key way information is taught and in almost any course, new vocabulary is learned. Vocabulary is defined to include the decoding of the written word, sightword recognition of the word, ability to hear the spoken word (auditory discrimination), ability to accurately pronounce the word, knowledge of the parts of speech (needed for using the word in communication), and the meaning of the word.

English is now the Lingua Franca, the language that people use to communicate when not speaking their native language—and much of the information, and many of the courses, are in English. The system has been optimized to make the teaching by language, and by the English language, as efficient as possible, as well as the teaching of language. The problem with English is that it is hard to learn as a significant proportion of the words in English are not pronounced as they are spelled.

Phonemes and Phonemic Awareness

There are a limited number of sounds that make up all words in a language. In English there are about 45 phonemes.

The sound /cat/ is made up of the sounds /c/ /a/ /t/. However, when a person says the word “cat” they do not spell out the letters /c/ /a/ /t/, but instead they say the distinct word “cat”. Long words are broken into syllables. People talk in syllables and not phonemes.

Knowing the word “cat” is made up of the sounds /c/ /a/ /t/ allows us to decode the sound of a written word—the sounds of the characters /c/ /a/ /t/ are close enough for us to recognize that the sound of the word is in fact “cat”.

Phonemic awareness is an essential skill for any reader of an alphabetic language.

When people listen to speech, they remember the sound of a word in their head, and the meaning of the sound. The person saying the word has to say it closely enough that it can be matched to the sound that is stored in our head. Phonemic awareness and being able to sound out a written word allows the user to improve the accuracy of the sound of the word store in the user's head, because the user can break the sound up into its components, discriminate the components, and put the word back together again. It is easier to remember a phonetic word that can be sounded out. If it is sounded out a few times, many people can remember it with only a small number of repetitions.

### Sound Symbol Association

Sound symbol association (e.g. the sound individual characters make), auditory discrimination, phonemic awareness and spelling are very tightly linked. As the student accurately learns the sounds of characters, the student starts improving their auditory discrimination of language sounds because the student accurately learns the sound of each character.

### The Auditory Problem

Children are born with a very high sensitivity to sounds. Children naturally focus on the sounds that their mothers make and they develop particular sensitivity for these sounds and start to interpret what these sounds mean. Over time, children lose sensitivity to some sounds but not others. Most children do not lose the ability to actually hear sound—they have normal hearing and their hearing is not harmed. What happens is that the do not develop or fully develop the neural pathways required to discriminate these sounds and understand the meaning of these sounds.

Children are born with the ability to make most sounds and they practice making sounds that their mothers want to hear. They gradually lose the ability to make some sounds which they don't hear and which they don't need to use.

The brain is plastic and for many people it is possible to develop these new neural pathways to help them better discriminate and understand sounds that they are not used to hearing and interpreting. The difficulty is that developing new neural pathways may take a lot of repetitious practice to develop and stabilize these new pathways.

### The Pronunciation Problem

Almost all children are able to speak and express themselves in a way that they can be understood in their native language. Children focus on imitating the sounds that their mothers make or making sounds that please their mothers. Over time some children lose the ability to make some sounds that are common in foreign languages. This is not because of some physical problem but that they don't have the neural pathways and the physical training to move their musculature in the way that is required to make the sounds. People who learn a foreign language later in life may never develop the coordination of the musculature to speak like a native but they can still be understood by native speakers if they practice the pronunciation.

### Pronunciation and Auditory Discrimination

If the student cannot hear the difference between how the student pronounces the word and how a native speaker pronounces a word then the student may have very little chance of improving their pronunciation of the word. This is because the student has no auditory feedback mechanisms which tell the student whether or not the student's pronunciation is accurate.

Recognition of Syllables and Words by Sight (Sightword Recognition) is the ability to look at a word and instantly recognize that sound of the word. This is a skill that is required for fluent reading. If the student has to sound out each word, then the student may find that their working memory is overloaded and that that they have significantly less mental concentration to devote to the meaning of what they read. Sightword recognition involves not only recognizing the shape of the characters but also the shape of the entire word. It is critical that any word mark-up system does not interfere with the shape of the word, otherwise the ability to develop sightword recognition will be compromised.

Teaching sightword recognition of syllables is an efficient way of teaching sightword recognition of multi-syllable words. There are 13, 802 words in the English dictionary database that contains only the most common 500 syllables. Students who learn to recognize these 500 syllables by sight can quickly learn to read by sight the 13,802 words made up of those syllables.

Description of Databases and Tools to Assist Users to Learn a Language or more Efficiently Use Language in their other Learning Activities.

Below is a list of databases from which users and teachers can import data to incorporate into Learning Activities as Learning Units, and a list of Learning Tools that can use this data to assist users efficiently learn a language or use language more efficiently in learning other subjects.

Language Dictionary. The following information is held for each language.
1. The 10,000 most common words by the frequency that these words are used in documents and conversations. This frequency listing is collected from external sources, e.g. research by linguists.
2. The 10,000 most common words broken into syllables which are generated by breaking the 10,000 words into syllables by adding syllable breaks to the words.
3. Mark up of the words and syllables showing exactly what sound each character makes.
4. The list of syllables by frequency of occurrence in the 10,000 most common words.
5. Words included in the Learning Units that are not in the 10,000 most common words.
6. Words that are added by individual students that are not part of the 10,000 most common words.

In respect of each word, the dictionary holds the following information:
1. Part of speech: (e.g. noun verb etc.).
2. Definition.
3. Pronunciation of the entire word. Several versions of this audio file can be stored corresponding to different accents.
4. Pronunciation of the syllables in the word. Several versions of this audio file can be stored corresponding to different accents.
5. Appropriateness—some words will not be appropriate for children or for people in particular User Classifications who are likely to be offended by the use of these words.

In respect of nouns, the dictionary holds the following information:

1. Type of noun (e.g. concrete noun, Proper Name).

2. Whether it is a plural.

3. Whether the plural is regular.

4. Collective noun (e.g. a parliament of owls).

In respect of verbs, the dictionary holds the following information:

5. Whether the verb is regular or irregular.

6. Tenses of the irregular verbs.

### List of Groups of Synonym

Synonyms are stored in groups of words with the same or similar meanings.

### Mark Up of Words in the Dictionary

In order to develop simple and fun repetitive learning activities, it is essential that there by just one sound per character. If characters can have more than one sound then the student will need to work out what sound the character will make based on context and is unlikely to develop the required automaticity in response for fluent reading, hearing and speech for a long time. In addition to breaking words into syllables—the basic units of speech—silent characters are greyed out and characters that have more than one sound are shown with a visual clue or glyph that will tell the user exactly what sound the character will make.

The above paragraph provides an example of Readable English in which the individual words are displayed using a word mark-up system that embeds a pronunciation guide for at least a portion of the word within the word without changing the spelling of the word.

Hesitation Analysis measures the Hesitation Factor for Learning Unit (LU) and stores it in the SKD. This provides a measure of automaticity of response. High degrees of automaticity are needed in a number of areas for mastery of a language.

Speech Analyzers.

The speech analyzers are third party products that will analyze recordings and provide detailed instant feedback to the student to assist the student to improve their auditory discrimination and their pronunciation. Users may select different outputs from the speech analyzers via the user interface customization. Different outputs include a scoring of the pronunciation of the entire word, a scoring of the pronunciation of each of the syllables in a word, and a graphical comparison of the wave forms of the correct pronunciation and the student's pronunciation. The way this information is presented for users in different User Classifications is under control of the optimization system.

Grammar Comparison Database.

For each language, the database contains grammatical rules and compares grammatical rules between languages so that users from one language need only be taught rules in the other language that are different. The rules in Grammar Comparison Database are ranked by the order the rules need to be taught.

Grammar is taught in stages of increasing complexity, with each stage including at least some of the following:

1. Vocabulary.

2. Verb tenses.

3. Parts of speech and word order.

4. Conjunctions and sentence construction.

5. Paragraph construction.

6. Comprehension.

Where a student knows one language and is learning a second language, the second language can be taught by comparing the rules of the two languages and the differences are taught. For example some of the similarities and differences between English and Urdu can be seen from the table below:

| English | Urdu |
|---|---|
| word order: subject verb object | subject object verb |
| word order: adjective precedes noun | same |
| pronouns different when used in the | no change of pronouns |
| subject from when used in the objects | between and object |
| e.g. I gave it, he gave me | subject |
| if A then B | same structure for |
| | if/then statements |

There are many grammar rules that have fallen out of use or are falling out of use. Some of these rules will not be included initially as they offer students few advantages. However requests to add new rules can be made by teachers.

Phoneme Comparison Database lists the phonemes in the International Phonetic Alphabet and maps the phonemes in each language to the IPA, which also creates a language to language table that identifies phonemes that are the same or very similar. Where some characters in a language have more than one sound, visual cues or glyphs are added to the word so that the student knows exactly what sound the character makes in that word. The student pronounces the glyph and not the character. Each glyph has one sound and this sound corresponds to a phoneme in the language. The IPA is a collection of phonemes from different languages. There is a one to one relationship between the glyph and the IPA character that represents the same sound. Students learning different languages using the system will therefore only need to learn the glyphs once and the same glyph will make the same sound in syllables or words in whatever language it is used in. This will enable learners to learn a sound/symbol association, phonemic awareness and auditory discrimination and have these skills apply to whatever languages they are learning. This will also enable spoken languages, like some indigenous languages that contain a new phoneme that is not used in mainstream languages written in the Roman Alphabet, like English. A linguist will select a glyph for the new phoneme, and a character that makes the closest sound in say English, and use the character glyph pair to represent the new phoneme in the Roman Alphabet. In addition, where the phonemes are the same in two languages, the sounds of the phonemes are spelled in that language.

| | Character | Example Word | Example Word | |
|---|---|---|---|---|
| IPA Character | Sound | in English | in French | Difficulty |
| [symbol] | /o/ | off | chope | Easy |
| i | /ee/ | eat | N [symbol] mes | Easy |
| [symbol] | /ahy/ | ice | ail | Easy |
| f | /p/ | pin | parfait | Easy |
| h | /h/ | hot | | Hard |
| [symbol] | /r/ | run | | Hard |
| Θ | /th/ | thumb | | Hard |
| [symbol] | /th/ | then | | Hard |

An example of a Phoneme Comparison Database entry is provided above.

The Phoneme Comparison Database is used to prioritize the teaching of phonemes, syllables and words. The phonemes that are the same or are very similar will probably not need to be taught, or if they do, the teaching will be quick. These are called the “easy Phonemes”. Syllables and words that contain just easy phonemes are easier to learn and are therefore taught before words containing “hard phonemes”.

The Phoneme Comparison Database also lists out the visual cues of glyphs that will unambiguously tell a student the sound that the character will make.

Phoneme Pronunciation Comparison Database

This is a database where each record consists of the following elements: <phoneme><Language 1, recording by a native speaker1 of language 1 of phoneme 1, recording by a native speaker2 of language 1 of phoneme 1><Language 2, pronunciation difficulty index, recording of phoneme 1 by a native speaker1 of language 2, recording of the phoneme by native speaker2 of language 2 etc.>

Recording by multiple speakers allows users to listen to the different accents and select the accents that they can best hear. Over time, as this data is collected, the User Classification information can predict which are the best accents to be used in a Learning Activity for a user in a particular User Classification based on the results displayed in the Outcomes Database.

The pronunciation difficulty index measures the difficulty of pronouncing the phoneme in the first language for people whose native language is the second language. The index is from 1-5 with 5 being the same phoneme in both languages and therefore easy to pronounce, to 1 being a very difficult phoneme—e.g. the English phonemes /I/ and /r/ for a Japanese speaker, and the phoneme /th/ as in “three” for a French speaker.

Database of Non-Words. This database is used to teach people phonemic awareness and is used because if real words are used, students who can recognize valid words by sight will use that recognition to access the stored sound of the word, and will be able to say the word without actively listening to the sound. Each language will have a database of non-words because some non-words in one language will be valid words in another language. Non Words are held in the following categories where “C” means consonant and “V” means vowel.

### CV

### VC

### VCC

### CCV

### CVC

### CCVC

### CVCC

### CCVCC

### Priming

Priming is a way of stimulating neural response by flashing up a word or an image on a screen for a very short period of time (e.g. 50 ms) before flashing up a second word or image.

Specific Games will be described using the Modules and Databases already described.

This overview refers to FIG. 1.

Each Learning Tool described in this document is designed as a separate Learning Activity having a Unique ID and reside inside the Learning Activity Database (LAD) 118.

The LAD 118 holds the XML for each of these learning tools and contains the detail, structure, sequence and content of the learning tools.

Once the Learning Activity is selected by LAS 114, it is packaged as Next Learning Activity 113 and sent to LAG 122.

LAG 122 receives and processes the Next Learning Activity 113 to create a Learning Interface 112 according to user device capabilities, platform features and screen size.

Choose or Lose Game
1. Teaches auditory discrimination and sound/symbol association
2. Teaches sightword recognition with syllables and words
3. Uses the following system tools/information
   a. User classification to select default accents.
   b. Phonemes and accents can be selected by the user from Phoneme Comparison Database and the Phoneme Pronunciation Comparison Database.
   c. Words and syllables from the Dictionary.

### Choose or Lose—Game Play

User clicks on “Play” tool on website. Taken to screen where they choose Category: “Sounds”, “Syllables” or “Words”.

Click on Sounds and are presented with the list of set games. If click on Syllables or Words, will get to screen with grid of all set games (only 1st game unlocked).

Click on one of the games, and are shown screen with “Difficulty Level—Slow, Medium, Fast”.

Final screen before play is the first page of the game and says, “Click the letter for the sound you hear”.

When game starts, user hears a sound and will see 4 stars falling from the top of screen. Each star displays a different character inside. These stars will travel towards the bottom of the screen at a selected speed “Slow (6 sec), Medium (4 Sec), Fast (2 sec)”.

The aim of the game is to TAP/Click/Hit the star with the correct character for the sound that is heard, before the stars disappear at the bottom of the screen. This repeats for 15 questions per game, each with different sounds and answer options.

The same Game Play is repeated with 1000 most used Syllables and 1000 most used words in English Language.

Unique Features
1—This gameplay is only possible due to the fact that each character in Standard English and Readable English has got exactly one sound.
2—Every sound used in this game will be available in two accents:
   a. English Speaker Accent
   b. Native Speaker Accent (speaker belongs to same region as user)
3—Sequence of taking the user progressively through the following:
   a. From easy character sounds to difficult character sounds
   b. 1000 most commonly used syllables in frequency of usage
   c. 1000 most commonly used words in frequency of usage
4—The display characters coupled with the sound in this game enable the user to improve auditory discrimination.
5—The 3 speeds allow users to make gradual progress, with the end result of instant recognition of the character, syllable or word sound.
6—FIG. 5 illustrates the learning interface of a game called the “Choose or Lose” game. Each game has 15 tries which are scored by the scoring control 501. The scoring control 501 records each number of correct, incorrect and missed tries out of 15. The user is required to recognize the sounds of phoneme, syllables or words played before each try. The user has to select one correct answer out of the four options which are denoted by falling stars 503. The feedback of the answer, as correct, incorrect or missed is provided by the in-game character 504. The timer control 502 shows the amount of time consumed by the user. A pause button 505 is also provided to pause the game between gameplay and resume when desired.
7—At the beginning of each game, the timer control 502 is set to 0 minutes and 0 seconds, the scoring control 501 is initially set to 0 for the count of correct, incorrect and missed answers. At the beginning of each try a sound is played, followed by that, 4 stars 503 appear on the screen with 1 of them containing the correct answer. The stars 503 move in a vertical top to bottom direction with speed based on the difficulty set for the user. The user has to select the correct star before they 503 reach the bottom of the screen and disappear.
8—When the user selects one of the falling stars 503, the game engine evaluates the response and the feedback is provided by the in-game character 504. The feedback would be either one of correct (if the user selected the correct star), incorrect (if the user selected the incorrect star) or missed (if the user did not select any star). The feedback is recorded by the scoring control 501. For each correct answer the correct answers counter is incremented by 1 count, for incorrect answers the incorrect answer counter is incremented by 1 count and the missed answers counter is incremented by 1 count for each answer that was missed.
9—The timer 502 keeps ticking till all the 15 tries are complete. It also stores the response time of the user for each answer.
10—Any time in between the gameplay the user can pause the game using the pause control 505. And the user can resume the game once he/she is ready to continue the game.

What's Changed Game
1. A Game to teach Phonemic Awareness and Auditory Discrimination
2. Played with characters not just blocks and this requires one sound per character
3. Uses nonsense words so that people do not confuse spellings and it makes people really listen
4. Foreign accents to native accents
5. Teaches both auditory discrimination and phonemic awareness
6. Uses the following system tools/information
   a. User classification to select default accents
   b. Phonemes and accents can be selected by the user from Phoneme Comparison Database and the Phoneme Pronunciation Comparison Database
   c. Non Words from the Non Word database

### What's Changed Game

### Game Play

Level 1—Beginner (Pick what changed)

Aim of game—to identify which sound changed in a word. E.g. if ‘sap’ is current word and ‘cap’ is next word, player would need to tap the ‘s’ identifying that it's the letter that changed.

When game starts player sees a word on the screen. User taps the audio button “next word” to hear the new word. User can also tap “This word” audio button if they need to hear the sound of displayed word.

Player needs to identify which sound changed by tapping on the letter that changed.

If the correct letter is chosen words appears in green in history list. New word with substituted letter is displayed on screen. Player again taps on “Next sound” audio button to hear the next word and keeps playing.

Previous words played show up in a list of words on score board—the starter word is not included in this.

If an incorrect letter is chosen, player tries again until they get it correct. Then that word in the list to the left will be colored red to show more than one attempt was needed to get the correct answer.

List on the right indicates if the word was played correctly on the first time, with either a tick or listed in red to show more than one attempt was made.

There are 10 tries per game. Each 10 games in a Category starts at CV/VC and progressively moves to CCVCC by the last game. C stands for Consonant and V stands for Vowels

### Level 2—Intermediate (Substitutions)

Aim of game—to identify the new sound coming in and what sound it is replacing. E.g. if ‘sap’ is current word and ‘cap’ is next word, player would need to drag/drop the ‘c’ from four multiple choice options, identifying that it's the new letter then drag and drop it over the ‘s’ to replace it as the substitution.

When game starts player sees a word on the screen along with 4 other letter options below it. User taps the audio button “next word” to hear the new word. User can also tap “This word” audio button if they need to hear displayed word.

Player needs to drag and drop the new sound from the 4 options and place it over the sound it is replacing.

If correct, word goes into list of previous words, and will be in green text (indicating correct)

If incorrect letter is chosen, the player needs to re-try until correct letter is placed in the correct spot. Then that word in the list to the left will be colored red to show more than one attempt was needed to get the correct answer.

There are 10 tries per game. Each 10 games in a Category starts at CV/VC and progressively moves to CCVCC by the last game.

### Level 3—Color Category

This category has all levels same as Level 1 and Level 2 (including pick only and substitute). The only difference is that instead of lettered tiles, user plays with colored tiles. Same rules apply as with letters.

When game starts player sees a number of different colored blocks on the screen (and 4 colored blocks options below to choose from—if playing Intermediate). User taps the audio button “next word” to hear the new word. User can also tap “This word” audio button if they need to hear displayed word.

Game play is exactly the same as Category Standard English and Readable English, except that tiles have no letters, only colors.

Unique Features
1—Improving the Phonemic Awareness of the user by playing closely related sounds.
2—Non-words are used in a pattern which improves the Phonemic Awareness.
3—Every sound used in this game will be available in two accents:
   a. English Speaker Accent
   b. Native Speaker Accent (speaker belongs to same region as user)

FIG. 6 shows a learning interface for a game called the “what's changed” game.

601 indicates a text display control that is the current word/syllable being displayed on the screen.

602 indicates a button control that will playback the audio of the current word/syllable displayed on the screen.

603 indicates a button control that will playback the audio of the next word/syllable for the user to guess.

604 are the drag-able tiles with choice letters, which the user has to drag and drop to form a correct word/syllable as heard after clicking button 603.

605 is the selected drag-able tile that is dragged to the drop zone that appears between and next to the letter composing the current word/syllable 601.

606 indicates a delete button for deleting or removing the letter from the 601 current word/syllable.

607 is the text display of word/syllable entered on first try. The light shade indicates a correct guess.

608 is the text display of word/syllable entered on a third try. The dark shade indicates an incorrect guess.

Grammar Games use the Grammar Comparison Database and User classification.

They display English sentences and have students mark up the parts of speech of each word by clicking on each word and selecting the part of speech from a list.

They display an English sentence and translate it into the foreign language in the foreign language word order for display. They enable the student to select the English words from a list and position the English words in the right word order using the interface.

They display an English sentence in the present tense and then enable the students to create a sentence in the past tense and future tense by dragging and dropping words from the sentence and from a list via the interface.

### Flashing Word Games

Sightword recognition is seeing a word and automatically knowing the sound of the word in the student's head. Sightword recognition is required for fluent reading, and fluent reading assists comprehension.

These games involve flashing a character, syllable, word etc. on a screen and having the student interact with the game via the user interface as listed below.

Flashing the character or syllable or word on the screen will improve the student's visual processing capacity and can increase the reading speed if it is limited by visual processing speed problems. Ultimately the factor that will limit the reading speed is the ability of the eye to scan the text.

The flashing game starts by the system displaying the word on the screen in the learning Interface in Standard English or in Readable English. Student interaction via the learning Interface may include:
1. Saying the character, syllable or word which is recorded, and which can be compared automatically to the correct sound of the word by a voice recognition system. The important feature for this game is that the system determines whether the student recognizes the word correctly, rather than whether the pronunciation is good. This will assist the student to develop sightword recognition as a general skill and to specifically recognize those words that are the subject of the game.
2. Enabling the user to type in the characters via the user interface. The characters are usually in Standard English as the system does not incorporate a Readable English keyboard. However, it will be understood that alternative keyboards may be incorporated. This teaches spelling as well as improving the visual memory
3. Enabling the user to drag and drop the Readable English characters or syllables to spell the word via the user interface.
4. Enabling the user to select (via the user interface) the right translation (for ESL) and/or definition of the word. This builds vocabulary.

The game variables that can be optimized by the system (the learning activity control module) include:
1. Varying the speed of the flashing word. The game may start slowly and then speed up based on a formula. The words that the student gets right will be shortened and the words that the student gets wrong will be slowed down until the students get them right. All results and user interactions are recorded by the system.
2. The length of time that a reader may need to read a word will vary with the length of the word. For example, longer words may require the reader to make one or more saccadic eye movements to see the entire word with high acuity. The student will be tested to enable the system to estimate the saccadic eye movement so that the words can be slowed down by the system to take into account the saccadic eye movements.
3. Figuring out what words a particular student has issues with and outputting easier words first. There are various patterns the system analyzes including the number of silent characters, the number of syllables, the number and type of glyph etc. and the system tests these hypotheses by outputting to the student words the system determines the user might have difficulty with and then analyzes the results.
4. Varying the size of the text and the Readable English glyphs to help transitioning to Standard English.
5. Priming the student by flashing up for say 50 ms (this time can be varied as can be the way the information is displayed—e.g. size and color) the following information:
   a. If the word being flashed is in Standard English, then prime using Readable English.
   b. If the student is studying English as a Second Language, the translation of the word into their native language.
   c. If the word is a concrete noun, flash an image of the noun.

### Hearing Word Games

A student hears a word via the learning Interface and the student can interact with the learning Interface by:
1. Drag and drop syllables and/or characters—this teaches spelling and also auditory discrimination
2. Choose the right translation for the word or the right definition using drag and drop or multiple choice—this teaches vocabulary

Variables include
1. Loudness
2. Length of sound
3. Accent
4. Speed of game
5. Hesitation—the system measures response time taken to answer a question. On some games, there might be a slower reaction time. The system measures this. The idea is that lower hesitation means more automaticity.

This game is optimized as per the auditory discrimination game.

One version of this game can include a feature when the student clicks a button to hear the word. When they click the button, the student can be primed with an image, word in Readable English or Standard English and a translation. It is optimized by the same process as priming above.

Specific Learning Tools

These will be described in terms of the above descriptions.

A Pronunciation and Auditory Discrimination Tool is provided with recording and advanced playback facilities that allow comparison of the user's recording with that of a native English speaker and a person from the same language background as the user, plus an Instant Feedback,
a. User classification to select default accents.
b. Phonemes and accents can be selected by the user from the Dictionary, Phoneme Comparison Database and the Phoneme Pronunciation Comparison Database, Pronunciation Tool, Hesitation Analysis, Priming.

### Pronunciation Tool

### Tool Usage

The idea for this tool originated from the focus study of group of Readable English users. The Readable English users mentioned the fact they can hear the pronunciation of words in generic online dictionaries but when they say it themselves they are not sure if they have got it right. The main objective of this tool is to provide instant feedback to the user for pronunciation of character, syllable or word.

User can select a character, syllable or word from the list. It will be placed on the screen. User can click the speaker icon to hear the Standard English pronunciation for selection. They can change the accent to Native English speaker if the prefer.

User can click the Microphone Icon and record themselves saying the same.

User can then create a sequence of advance audio playback by drag/drop of the Speaker and Microphone tiles.

User can adjust the distance between the tiles to increase or decrease the gap between the audio components present in advance playback.

Unique Features
1—The advance playback of user recording and standard recording in quick succession as a feedback mechanism for user to note the differences in pronunciation.
2—The interface allows the user to control the time delay between the components of advance playback.
3—Advance playback allows user to create a sequence of audio playback according to their requirement by mixing standard and user recording.
4—User can select Standard or Native English Speaker accent to practice and match their pronunciation with.
5—Graphical Waveform Analysis output by CMU (Open Source Speech Recognition) will be displayed to the user as an additional feedback.
6—A more simple form of scoring the user recording against the Standard or Native English speaker will be displayed to the user as an additional feedback.
7—The Video recording feature will allow a user to record a video of their pronunciation and then compare it with the Standard English pronunciation video for instant feedback. For example, a web cam or camera attached to the user's computer may focus on and record the user pronouncing the word (or portion thereof). This video file may then be played back adjacent a pre-recorded video of a non-native or native language speaker uttering the same sound. The user can position, synchronize or super-impose the images to enable the playback of both the user's video to coincide with the pre-stored video.

FIG. 7 illustrates the User Interface of the Pronunciation tool. The display contains a Lesson Content List 701. From which the Learning Unit is loaded one by one in the Content Display control 702, and this control 702 allows the user to view the Learning Unit in Standard English or Readable English.

The user will be able to play the Lesson Unit and record their pronunciation sound using the Learning Control 703. The user can play the recorded audio and re-record the sound if it was not audible.

The audio file of the Lesson Unit and the User Input, are displayed as symbols that can be dragged and dropped in the Advanced Playback Control 704. The Advanced Playback Control 704 would be played by the user to listen to the Learning Unit and the User Input in succession to compare both the sounds. The order of the playback is defined by the organization of the sound symbols and the delay between successive sounds can be adjusted according to the User's preference.

The video playback feature is also provided to show mouth movement. In addition, video images of the user may be recorded while they pronounce the word in order to enable them to view both their movement and the mouth movement of a native speaker, for example.

### Vocabulary Builder

### Tool Usage

The objective of this tool is to teach people vocabulary in an interactive way with a highly customizable interface setup by user him/herself.

With the help of timeline and drag/drop features, the user controls the following features:
1—Components to be displayed on the screen.
2—Sequence they should follow.
3—Time Interval between these components.
4—Additional properties of each components like priming, position and formatting.

Unique Features
1—Priming: Display a related artifact like image or translation of the word for 10-100 ms before the actual word is displayed on the screen.
2—Unlike conventional system where all the information is pushed to the user in one go, in a fixed format, this tool displays the information in form of small components.

FIG. 8 shows a user interface for a vocabulary builder tool.

801 is the List Control containing all components for vocabulary builder tool interface.

802 is the Interactive Timeline Control. User can drag and drop the components from 801 list and drop them over the specific location on timeline 802.

803 is the Definition component dropped at a specific location on the time line. This component will appear on the screen at the specified time per its location on time line.

804 is the label which shows that a PRIMING controls is present and setup for this component. For example in case of 804, the WORD component displays the word on screen. Before the word is displayed the PRIMING can happen for 10-100 millisecond with the following objects:

1. Translation in native language.

2. Image.

805 is the actual display area of the component.

FIG. 9 shows the detail of the individual components in the vocabulary builder interface.

901 is the main display area where the text/image or multimedia content will be shown.

902 is a control icon to open the property dialog, which will be used to modify the properties of this component e.g. font, font size, font color, priming etc.

903 is an integer icon indicating the order of this component in the sequence or on the timeline.

904 is the priming indicator icon showing that priming is available and has been enabled for this component.

905 is the integer value icon that depicts the time delay after which this component will appear on screen after the previous event (the previous event being the appearance of prior component).

906 is a button that allows the user to hear the content/text of the component in English or their native language (translated).

907 is a button that allows the user to close the component and remove it from the screen.

908 is a control icon that allows the user to reposition this component anywhere on the screen.

909 is a control icon that allows the user to resize this component to display its content properly.

FIG. 10 shows the Playback mode interface for the vocabulary tool.

1001 is the label icon which shows the total number of words and current word in this set for vocabulary set.

1002 is the playback button which will start the playback according to the timeline.

1003 is a rewind icon that will allow the user to step back to the previous word in the vocabulary set.

1004 is a forward icon that will allow the user to step forward to the next word in the vocabulary set.

Benefits of various aspects of the system (whether in isolation or combined) include, but are not limited to:
1. Teaching language by using Biological Primary information. People are not taught their native language—they just learn it. This is Biological Primary learning. Syllabification and silent characters are Biological Primary. There is little or no need to teach sightword recognition of Standard English words when the student can read Readable English words by sight—this is part of the innate nature of the human mind and is Biological primary learning.
2. Teaching a foreign language by reference to the native language of the student. A database of sounds, words and rules that lists all the phonemes, their sounds, the parts of speech, the word order rules, tenses, grammar rules etc. in English and in foreign languages is created and used to teach the student what is different in the new language from the native language.
3. Students from a non-native English language background can hear phonemes, syllables and words pronounced by a native English speaker and by a speaker of their native language, and they can compare the recording of their own attempts to make the pronunciation with these two provided recordings to assist them develop auditory discrimination.
4. Providing simple, fun and easy to play games to encourage students to practice and as a result, to develop a high level of automaticity in key language skills. Key language skills include sound symbol association (students know the sound of each character), phonemic awareness (/sat/ is made up of /s/ /a/ /t/ and /s/ /a/ /t/ makes the sound /sat/), auditory discrimination (the ability to accurately discriminate the sounds of phonemes, syllables and words so that the student can accurately recognize the sound) and sightword recognition (being able to see a word and know instantly what the sound of the word is). Learning a language requires students to develop a high degree of automaticity in the above skills. If students are not able to develop a high degree of automaticity, their working memory will be overloaded by the activities of decoding the sound and meaning of the word and they will have little working memory for comprehension. The way to develop these skills is through deliberative practice—the desire to get better through practice. Gamification (i.e. using games) provides additional incentive to improve results. A key aspect of this is that there is just one sound per character.
5. By having the system provide instant feedback to students whether they have learned something accurately or not.
6. By having the system suggest learning interventions for particular groups e.g. how to make a particular sound with your mouth. This may be difficult and the system may be set up to systematically try different ways to teach a student. It is not so much about optimizing but in systematically finding something that works. It may also take a lot of practice. The system may be setup to try out a lot of different instructions on different people and determine what works for different sets of students. The system analyzes the User Classification of a student and determines what worked for other students with a similar User Classification and then the system provides the student an instruction that the system has estimated to be the most likely to work followed by the next most likely etc. The student may determine that students need to try a lot of different ways to find one that works and that students may need to practice a lot to develop the new neural pathways. The system may output Learning Activities that use people's voices that have strong accents to help students develop their auditory discrimination and then progress to native speakers over time. The system may be utilized to get the student to pronounce syllables that will get them to develop their auditory and pronunciation skills and the selection of the syllables and order in which they are taught may be important for particular students.
7. By teaching language in the most efficient order: phonemes, syllables and then words. Knowing the phonemes and having simple decoding rules—one sound per character—allows a student to quickly learn to decode the sound of syllables. There are 11 words made up just of the most common 500 syllables. If a student learns the most common 500 syllables, they will be able to accurately decode the sound of 11 words.
8. By teaching the most common syllable and words first.
9. By splitting learning from revision. Students can learn efficiently in an individually optimized way to learn new information and students may revised efficiently in an individually optimized way that may be quite different from how the student learns and the revision cycle is optimized for the student.
10. By allowing individual customization of activities—the user can select different interfaces and this will in some instances determine the order in which the student is being taught. The system logs this data and determines what interfaces work best for what student or class of students so that the system can suggest interfaces to new students of the same class. This essentially crowd sources the interface in order to find an interface that is particularly effective in helping particular individuals or types of individuals learn. Further, the system enables users to customize the revision cycle.

By systematically developing, testing and applying new learning hypotheses. Querying the Log File database and outputting the results of the query into a statistical analysis or machine learning system will enable the testing of new learning hypotheses if there is sufficient data to provide statistically significant results. If there is not sufficient data, specific experiments using specifically designed Test Learning Patterns can be set up and run manually to collect specific data to test the hypothesis. Users with specific User Classifications can be selected to use the Test Learning Patterns to provide the required data.

The herein described system and method incorporates specific naming convention and link management. In particular, the following features are incorporated.
1. A strict naming convention may be provided for any external file that is to be added to a lesson—e.g. audio, video, games files etc. This may have a native accent, for example, built into the file name so that it is unique and to ensure that the user of the system receives the correct file in the lesson.
2. There may be a link management system and/or database that rapidly sends the external file to the display module. There may be an object oriented database where the system sends the request for the external file to or there may be a link table that is regenerated automatically when there is a change in the directory where the external file is stored to enable the system to retrieve the external file.
3. An object oriented database may store all the external information as well as the lesson content. This may be located in a defined place on the local device and on the website and may contain one or more of the audio, image, video, XML lesson content and the offline logging entries.
4. The system may automatically test that a file actually exists on the server and that the file complies with the defined naming convention.

In addition, the herein described system and method provides a lesson creation module that enables lessons to be created by the user of the system or method.

For example, the lesson creation module may be executed on a Personal Computer and controlled with a mouse. A list of learning activities (LA) may be displayed on the right of the screen, for example. A teacher may select the LAs by dragging them into position onto the left of the screen with the top positioned lesson being the first lesson, followed by the second lesson underneath etc.

The teacher may then add data to the lesson by:
1) selecting a default accent—if there is more than one accent in the lesson, an error message may be generated and displayed;
2) filling in a form e.g. by displaying a list of Multiple Choice Questions, where a question has 4 answers. The teacher may click the box to indicate to the system which is the correct answer. Further, the teacher may identify to the system what steps should be taken should the incorrect answer be provided. Also, the teacher may fill in the missing word game by typing in the sentence, tagging the missing word, and adding three additional words, for example. It will be understood that the teacher may identify any future actions for the system to perform depending on the context and outcome.
3) selecting words to be taken directly from the database by typing in the first few characters of the desired word and then selecting the English or RE word based on those initial characters. That is, the system performs a match on the characters entered with the words stored in the database and retrieves and displays the matched words for the teacher to select for use in the lesson. The teacher chooses the word from the database entry, rather than typing the word afresh, to ensure that the word is in the database and that the spelling is correct.
4) selecting a desired external file (in a similar way to 3 above) from a list of available external files using the defined naming convention. This is to ensure that the naming convention is adhered to. Therefore, the lesson creation module ensures that the external file naming convention is strictly adhered to for the external files including audio, images, videos etc.

The teacher may then link the LA's to other LA's to form a chain of LA's which will comprise a lesson.

For example, in the lesson the teacher may require text followed by four questions. To create the lesson, the teacher may select the text display LA and the associated document ID, and then subsequently select the LA which has the multiple choice questions. The teacher may enter the information in the questions and answers. The teacher may then create a chain of LA's by selecting each La in sequence. Therefore, according to this example, the text LA would precede the MCQ LA so that the student sees the text and then gets the MCQ's afterwards.

The lessons may then be tested before the lessons go live to the students. The system makes sure that all links are filled in by following all the links to determine whether each link pointer has a valid link target. The system also makes sure that the lesson ends no matter what choices the user makes by following every link path through the lesson to determine if the lesson concludes via each path. Further, the system makes sure that all the words to be displayed are in the dictionary by comparing each word to a dictionary set of words. For example, a US spelled word in an Australian lesson may indicate an error. The system also checks that formatting display rules are followed. For example, the system may have character count limits in a display box and so the system may check that the rules are complied with by counting the number of characters and comparing the number of characters to the maximum number of characters allowed in the box.

The system therefore ensures that different things that may go wrong are checked. For example, the system checks that i) the file names follow the defined convention, ii) the files exist, iii) the lesson is properly linked and so on.

All new audio recordings and videos etc. may be checked manually by someone to make sure that the new information is correct and correctly tagged before they become live on the system. A checking audit trail is recorded by the system.

XML files may be run through an XML validator to make sure that the XML file complies with the schema. Examples of XML errors that may be determined by the XML validator include, but are not limited to, a multiple choice question that does not have the required number of answers, or a voice recording that does not have a valid accent tag. XML errors can also be located manually when a lesson does not display or respond as expected. If an error is located in the XML then the error will be logged and the system may be updated so that the error does not reoccur.

Lesson Content may be stored in XML. The XML code is used to drive the lesson display and populate the navigation bar with Learning Activities and the Learning Activities with data. It is desired that the XML text does not create problems with firewalls so the content is limited to text, audio files etc. that are not compiled code. The system may extract from the dictionary words in the lesson and the videos in the correct accent for download.

When maintaining a lesson via the system, the system keeps version control and notifies teachers who use this lesson that the lesson has been changed. This allows the teachers to upgrade if they want to. A short description in the XML file maybe provided identifying what the changes are why they were made. This may save teachers time in deciding whether they want to upgrade. The elements that have been changed may be flagged, possibly with the change flagged too.

Therefore, the lessons may be stored in XML files. Data related to the lesson may be obtained from or via the XML file. For example, part of the XML file may name the learning activity while another part has associated data or a link to data (such as audio or a video). The XML file may be used to construct schema for lessons enabling a user to download the schema. The lesson may then be executed via HTML5 on a website or by executing an “App” on a suitable device such as a smart phone or tablet, for example.

Therefore, according to one or more aspects (whether alone or in combination), there are provided various improvements to known systems. These improvements may be utilised by the system (or its associated method) either alone or in combination with one or more other improvements. These improvements include, but are not limited to, the following.

A teaching system or method that teaches a complete curriculum by logging all the Learning Units and by teaching them.

A system or method that Logs the Learning Units that need to be revised and systematically revising these Learning Units.

A teaching system or method that splits learning activities from revision.

A revision system or method that optimizes the revision timing.

A revision system or method that optimizes revision by selecting the Learning Tools used by the student that have the best outcome.

A revision system or method that optimizes both the timing and the selection of the revision tools.

A teaching system or method that use the Skills prerequisite to send error messages if LA uses skills the student does not know when creating a learning Activity of Learning Pattern.

A system or method for selecting a document (e.g. a learning unit) for an individual from a group of documents by comparing the profile of the document with the profile of the user stored in the SLKD for that individual and choosing the document with the best match.

A system or method for selecting a document (e.g. a learning unit) for an individual from a group of documents by comparing the words in the document with the words in the SLKD for that individual and choosing the document with the greatest number of known words.

A system or method for selecting a document (e.g. a learning unit) for a member of a User Classification based on a group of documents by selecting documents based on matching the document profile with profile of the User Classification Language Knowledge Database.

A system or method that enables crowdsourcing of new learning activities which will suggest new approaches to learning issues.

A system or method that collects and logs the data in great granularity.

A system or method flags those new approaches that work for particular user classifications.

A system or method that allows researchers to quickly and easily set up new experiments to test these new approaches.

A system or method that enables crowdsourcing of new learning activities which will suggest new approaches to learning issues and generate a lot of data, and then locate relationships within the data.

A system or method that enables crowdsourcing of new learning activities which will suggest new approaches to learning issues and generate a lot of data, and then locate multivariable relationships within the data.

A teaching system for teaching a user. The teaching system may comprise a learning interface module, a user classification module and a learning activity control module. The learning interface module may be arranged to receive user information associated with a user and store the user information in a user information database. The user classification module may be arranged to obtain a user classification code based on the user information and store the user classification code in a learning outcome database. The learning activity control module may be arranged to select at least one learning activity from a learning activity database based on the user classification code and communicate the selected learning activity to the learning interface module for reception by the user.

When the user classification module obtains the user classification code, this may be when a new user is assigned a first user classification code or when an updated classification code for an existing user is obtained, or when an existing user classification code for an existing user is obtained.

When the learning activity is communicated to the learning interface, the learning activity may then be output or rendered to an output device. It will be understood that the output device may be a computer screen, mobile phone screen, TV screen, speaker etc.

The learning interface module may be further arranged to receive from the user interaction data while the user is interacting with the learning activity. The interaction data may be stored in the user information database. The learning interface module may be further arranged to communicate the interaction data to the user information database and a learning outcome database against a user ID associated with the user, the user classification code and a learning activity code associated with the learning activity.

It will be understood that although the databases are described herein and indicated in the figures as separate databases, one or more databases may be combined into a single database. Further, it will be understood that the databases may be located in one or more locations, such as on different computing systems and/or stored in different computing environments and networks. For example, one or more databases may be located on a computing system accessible via a network such as the Internet.

The interaction data may comprise data associated with one or more of a skill learned and a result associated with the user interacting with the learning activity.

The system may further comprise a machine learning system, where the machine learning system may be arranged to retrieve the interaction data, extract features from the interaction data and classify the extracted features.

The machine learning system may be further arranged to operate in one of three modes selected from the group comprising: supervised mode; semi-supervised mode; unsupervised mode.

The teaching system may be a language teaching system for teaching a user a language and the learning activities may be activities for teaching a user to speak, pronounce, understand or learn the language.

The learning activity control module may be arranged to control the learning activity based on two or more selected from the group consisting of: the user information; the user classification code, the user ID, interaction data received from the user.

The learning activity control module may be further arranged to control the learning activity by dynamically optimizing data associated with the selected learning activity.

The user information may comprise one or more of demographic information associated with the user, the user's age, the user's native language, a region where the user did or currently resides, a desired proficiency level of the user associated with a defined language, one or more preferences associated with the user, the user's proficiency level in the user's native language, and the user's proficiency level in the language the user is learning.

The learning activity control module may be further arranged to retrieve a desired proficiency level from the user information in the user information database and determine which learning activity is selected from the learning activity database based on the desired proficiency level.

The learning activity control module may be further arranged to select the learning activity to be retrieved from the learning activity database based on a determined form of the learning activity, wherein the determined form may comprise one or more of a display format that promotes subliminal messaging, a display format that primes the user of at least a portion of the learning activity, audio data that is associated with a voice that has an accent that is associated with the user information, a text format for displaying the lesson data, audio data comprising a controllable variable playback speed, and audio data comprising variable and discernible gaps between discrete audio portions of the audio data.

Subliminal message may occur during priming of the user. Further a display format may prime the user of at least a portion of the learning activity (e.g. a learning unit) that is to be output. Also, audio data may comprise variable and discernible gaps between discrete audio portions of the audio data are described with reference to the advanced playback process in the pronunciation tool, wherein this feature may be set by using the timeline.

The learning activity may comprise audio data that is associated with a voice that has an accent that is associated with the user information, and the learning activity control module is further arranged to control and vary the audio data based on the interaction data.

The learning activity control module may be further arranged to control and vary the audio data based on a range from varying similarities to the accent associated with the user information to varying similarities to an accent associated with a language being taught.

The learning activity control module may be further arranged to optimize presentation of the selected learning activity based on the interaction data.

The learning activity control module may optimize the presentation of the learning activity by one or more of controlling the speed of playback of an audio and/or video file, and controlling a format of the learning activity to be output.

The learning activity control module may be further arranged to detect a learning problem associated with a first set of interaction data. It may compare the first set of interaction data with the interaction data stored in the user information database to determine a match between the first set of interaction data and the interaction data. It may control the learning activity based on the comparison.

The learning interface module may comprise an audio and/or video capture module arranged to capture audio signals and/or video signals associated with the interaction data. The learning activity control module may be further arranged to compare the captured audio and/or video signals with audio and/or video signals associated with stored interaction data.

The learning activity control module may be further arranged to control the learning activity by outputting one or more of instructions on how to correct pronunciation, one or more videos indicating how to correct pronunciation, and one or more sound wave images indicating where pronunciation is inaccurate.

The learning activity control module may be further arranged to analyze the performance of the user while interacting with the learning activity. The performance of the user may be analyzed by analyzing the interaction data in association with the user information and the user classification code.

The learning activity control module may be further arranged to detect hesitation from the user within the interaction data while the user is interacting with the learning activity. The learning activity control module may be further arranged to control the learning activity based on any detected hesitation.

The learning activity control module may be further arranged to analyze the interaction data to determine reading ability associated with the user while the user is interacting with the learning activity. The learning activity control module may be further arranged to control the learning activity based on the determined reading ability and the user classification code.

The learning activity control module may be further arranged to determine what the user knows and/or doesn't know based on the interaction data and the user information. The learning activity control module may be further arranged to control the learning activity based on the determined knowledge or lack of knowledge and the user classification code.

The learning activity control module may be further arranged to determine long term memory ability associated with the user based on the interaction data and the user information. The learning activity control module may be further arranged to control the learning activity based on the determined long term memory ability and the user classification code.

The system may further comprise a teaching module, wherein the interaction data may be associated with at least one skill learned that is associated with information that has been taught by the teaching module and learned by the user.

The learning activity may comprise at least one learning tool.

The learning tool may be arranged to improve learning outcomes via an optimization process performed by the learning activity control module based on at least the interaction data and the user classification ID.

The optimization process may be a multivariable optimization process.

The learning activity control module may further comprise a teaching module and the learning activity may comprise a plurality of learning tools. The teaching module may be arranged to teach a complete curriculum using the learning tools.

The interaction data may be associated with at least one skill learned that is associated with information that has been taught by the teaching module and learned by the user, wherein each skill learned is stored in a learning outcome database.

The learning activity control module may be arranged to select the learning activity by determining which learning activity has the highest probability of success based on the user classification code.

The system learning activity control module may be further arranged to obtain a set of results from the learning outcome database based on the user classification code and apply a ranking algorithm to the set of results to determine the learning activity for selection.

The learning activity control module may further comprise a teaching module and a revision module, wherein the teaching module is arranged to teach the learning activity and the revision module is arranged to revise the learning activity. The revision may be separate from the teaching.

The system may further comprise a design interface module. The design interface module may be arranged to receive a list of learning activities arranged in a learning pattern as a defined order, access a prerequisite skill list and determine whether the learning pattern is not suitable for the accessed prerequisite skill list, and upon a positive determination, generate an error message.

The learning activity may comprise a plurality of learning units that are associated with information being taught by the teaching module and learned by the user. The system may further comprise a revision module arranged to determine which of the learning units are to be revised based on the interaction data and the user classification code.

The system may record each learning unit that a user has completed. The system may then use that information to determine which learning units have been taught by the teaching module and so are available for revision purposes.

The revision module may be further arranged to determine a revision schedule for the user based on revision schedules that provided a successful outcome for other users having the same user classification code.

The system may further comprise a phoneme comparison database that is arranged to list the International Phonetic Alphabet phonemes and map phonemes in a plurality of languages to the International Phonetic Alphabet to create a language to language table that identifies phonemes that are the same or very similar.

The learning activity control module may be arranged to determine whether characters of a first word in a first language in the learning activity has more than one sound using the phoneme comparison database, and upon a positive determination, add visual cues or glyphs to the first word in the learning activity.

The learning activity may comprise a plurality of learning units, and the learning activity control module may be further arranged to select a learning unit from a group of learning units based on matching a learning unit profile with a user profile.

The learning activity control module may determine which of the learning units has the greatest number of words that match the words stored in the SKLD for that user. The learning activity control module may then select that learning unit for use in the learning activity.

Also, for a user in a particular User Classification, the learning activity control module may determine which learning unit(s) to select for the learning activity by determining which of the learning units has the greatest number of words that match the words stored in the UCLKD for that user.

The learning activity may comprise a plurality of learning units, and the learning activity control module is further arranged to compare the words stored in a user knowledge database with the words in the learning units and select a learning unit based on the comparison.

The learning activity may comprise a plurality of learning units, and the learning activity control module is further arranged to select a learning unit from a group of learning units based on matching a learning unit profile with the user classification code.

A teaching system for teaching a user. The system may comprise a learning interface module and a learning activity control module. The learning interface module may be arranged to receive user interaction data associated with a user's interaction with a learning interface. The learning activity control module may be arranged to select at least one learning activity from a learning activity database and communicate the selected learning activity to the learning interface module for display on the learning interface. The learning activity may be arranged to utilise game processes with repetition.

The system may be language teaching system, wherein the learning activity may be further arranged to include one or more of sound symbol association, phonemic awareness, auditory discrimination, pronunciation and learning vocabulary.

A computer implemented method for teaching a user. The method may comprise a processor performing the following steps. Generating a learning user interface to enable a user to interact with a learning activity. Generating a learning activity, wherein the learning activity may be arranged to utilise game processes with repetition.

The learning activity may be further arranged to include one or more of sound symbol association, phonemic awareness, auditory discrimination, pronunciation and learning vocabulary.

A teaching system for teaching a user. The system may comprise a learning interface module and a learning activity control module. The learning interface module may be arranged to receive user interaction data associated with a user's interaction with a learning interface. The learning activity control module may be arranged to select at least one learning activity from a learning activity database and communicate the selected learning activity to the learning interface module for display on the learning interface. The learning activity may be a language learning activity arranged to output one sound per character of a word being taught.

A computer implemented method for teaching a user. The method may comprise a processor performing the following steps. Generating a learning user interface to enable a user to interact with a learning activity. Generating a learning activity, wherein the learning activity is a language learning activity arranged to output one sound per character of a word being taught.

A teaching system comprising a learning interface module and a learning activity control module. The learning interface module may be arranged to receive user interaction data associated with a user's interaction with a learning interface. The learning activity control module may be arranged to select at least one learning activity from a learning activity database and communicate the selected learning activity to the learning interface module for display on the learning interface. The learning activity may be a language learning activity arranged to output a word using a word mark-up system that embeds a pronunciation guide for at least a portion of the word within the word without changing the spelling of the word.

A computer implemented method for teaching a user. The method may comprise a processor performing the following steps. Generating a learning user interface to enable a user to interact with a learning activity. Generating a learning activity. The learning activity may be a language learning activity arranged to output a word using a word mark-up system that embeds a pronunciation guide for at least a portion of the word within the word without changing the spelling of the word.

A teaching system comprising a learning interface module and a learning activity control module. The learning interface module may be arranged to receive user interaction data associated with a user's interaction with a learning interface. The learning activity control module may be arranged to select at least one learning activity from a learning activity database and communicate the selected learning activity to the learning interface module for display on the learning interface. The learning activity may be arranged to output a word using a word mark-up system that embeds a pronunciation guide for at least a portion of the word within the word without changing the spelling of the word.

The learning interface module may create, generate, output or display a learning interface.

A computer implemented method for teaching a user. The method may comprise a processor performing the following steps. Generating a learning user interface to enable a user to interact with a learning activity. Generating a learning activity. The learning activity may be arranged to output a word using a word mark-up system that embeds a pronunciation guide for at least a portion of the word within the word without changing the spelling of the word.

A teaching system comprising a learning interface module and a learning activity control module. The learning interface module may be arranged to receive user interaction data associated with a user's interaction with a learning interface. The learning activity control module may be arranged to select at least one learning activity from a learning activity database and communicate the selected learning activity to the learning interface module for display on the learning interface. The learning activity may be a language learning activity and may be arranged to output, in order, phonemes of a word being taught, syllables of the word being taught and then the word being taught.

That is, lesson units may be selected and positioned in a particular order within the learning activity such that the phonemes of a particular word are output first to the user, then the syllables of that word are output to the user, and finally the whole word is output to the user.

A computer implemented method for teaching a user. The method may comprise a processor performing the following steps. Generating a learning user interface to enable a user to interact with a learning activity. Generating a learning activity. The learning activity may be a language learning activity and may be arranged to output, in order, phonemes of a word being taught, syllables of the word being taught and then the word being taught.

A teaching system comprising a learning interface module and a learning activity control module. The learning interface module may be arranged to receive user interaction data associated with a user's interaction with a learning interface. The learning activity control module may be arranged to select at least one learning activity from a learning activity database and communicate the selected learning activity to the learning interface module for display on the learning interface. The learning activity may be a language learning activity and may be arranged to separate a word being taught into its syllabic components and display the individual syllables of the word.

That is, lesson units may be selected and positioned in a particular order within the learning activity such that the syllables of the word being taught are output to the user to indicate how the word is made up of the syllables.

A computer implemented method for teaching a user. The method may comprise a processor performing the following steps. Generating a learning user interface to enable a user to interact with a learning activity. Generating a learning activity, wherein the learning activity is a language learning activity and may be arranged to separate a word being taught into its syllabic components and display the individual syllables of the word.

A teaching system comprising a learning interface module and a learning activity control module. The learning interface module may be arranged to receive user interaction data associated with a user's interaction with a learning interface. The learning activity control module may be arranged to select at least one learning activity from a learning activity database and communicate the selected learning activity to the learning interface module for display on the learning interface. The learning activity may be a language learning activity and may be arranged to display silent characters in a word being taught in a different format to other characters in the word.

That is, the learning activity may display silent characters as “greyed out” characters to indicate to the user on the learning interface that those characters are not to be spoken. For example, the silent characters may be displayed in a literally grey font, whereas the remaining non-silent characters may be displayed in a black font. It will be understood that other color schemes or forms of displaying the silent and non-silent characters may be used. As a further example, a font maybe used where the silent characters are shown in a dotted or dashed line format, and the non-silent characters are shown in a full line format. That is, the non-silent characters may be displayed in a first format, whereas the silent characters may be displayed in a visually different format to indicate that the character is a silent character.

A computer implemented method for teaching a user. The method may comprise a processor performing the following steps. Generating a learning user interface to enable a user to interact with a learning activity. Generating a learning activity. The learning activity may be a language learning activity and may be arranged to display silent characters in a word being taught in a different format to other characters in the word.

A teaching system comprising a learning interface module and a learning activity control module. The learning interface module may be arranged to receive user interaction data associated with a user's interaction with a learning interface. The learning activity control module may be arranged to select at least one learning activity from a learning activity database and communicate the selected learning activity to the learning interface module for display on the learning interface. The learning activity control module may be further arranged to detect an accent selection from the user and the learning activity may be arranged to output audio signals based on the accent selection.

That is, the user may select specific learning activities that output audio signals in an accent chosen by that user. This is intended to assist the user in learning the language by first listening to the foreign words being spoken in an accent that they are familiar with. That is, the accent selected is not an accent that is usually associated with the language being learnt. In other words, the accent selected is an accent for a language that is different to the language being learnt. For example, the accent may be an accent of the native language of the user. The system may provide a list of accents for the user to select from based on the user classification code associated with that user.

A computer implemented method for teaching a user. The method may comprise a processor performing the following steps. Generating a learning user interface to enable a user to interact with a learning activity and select an accent. Generating a learning activity, wherein the learning activity is a language learning activity and may be arranged to output audio signals based on the selected accent.

A teaching system comprising a learning interface module and a learning activity control module. The learning interface module may be arranged to receive user interaction data associated with a user's interaction with a learning interface. The learning activity control module may be arranged to select at least one learning activity from a learning activity database and communicate the selected learning activity to the learning interface module for display on the learning interface. The learning interface module may be further arranged to capture pronunciation of at least a portion of a word. The learning activity may be arranged to compare the captured pronunciation of words with a pre-stored pronunciation of at least a portion of the word.

The learning activity may be arranged to display the comparison and enable the user to adjust the display of the comparison.

The learning activity may be arranged to display the comparison, and the learning activity control module may be arranged to optimize the display based on a user classification code associated with the user and the user interaction data.

That is, the user may select to record their pronunciation either before or after hearing how the word should be pronounced. The pre-stored pronunciation may be from a native or non-native speaker of the language being taught. For example, the pre-stored pronunciation may be from a non-native speaker who comes from the same country of the user. The user may select to capture at least a portion of the word, such as a phoneme, a syllable or the whole word. This provides auditory discrimination as well as pronunciation learning capabilities.

The learning activity may be generated so that the user may modify how the pronunciations or the comparison of the two pronunciations are displayed on the learning interface. This may then assist the user in understanding the difference between the user's pronunciation and the correct pronunciation.

A computer implemented method for teaching a user. The method may comprise a processor performing the following steps. Generating a learning user interface to enable a user to interact with a learning activity and capture pronunciation of at least a portion of a word. Generating a learning activity. The learning activity may be a language learning activity and may be arranged to compare the captured pronunciation of words with a pre-stored pronunciation of at least a portion of the word.

The method may further comprise the steps of the processor displaying the comparison and enabling the user to adjust the display of the comparison.

The method may further comprise the steps of the processor displaying the comparison, and optimizing the display based on a user classification code associated with the user and the user interaction data.

A teaching system may comprise a learning interface module and a learning activity control module. The learning interface module may be arranged to receive user interaction data associated with a user's interaction with a learning interface. The learning activity control module may be arranged to select at least one learning activity from a learning activity database and communicate the selected learning activity to the learning interface module for display on the learning interface. The learning activity may be a language learning activity and may be arranged to generate non-words.

That is, the learning activity outputs phonemes or syllables that together do not make up a word that is known or commonly known in the language being taught. This teaches the user phonemic awareness.

A computer implemented method for teaching a user. The method may comprise a processor performing the following steps. Generating a learning user interface to enable a user to interact with a learning activity and capture pronunciation of at least a portion of a word. Generating a learning activity, wherein the learning activity is a language learning activity and may be arranged to generate non-words.

A teaching system may comprise a learning interface module and a learning activity control module. The learning interface module may be arranged to receive user interaction data associated with a user's interaction with a learning interface. The learning activity control module may be arranged to select at least one learning activity from a learning activity database and communicate the selected learning activity to the learning interface module for display on the learning interface. The learning activity control module may be arranged to compare a first set of grammar rules associated with the native language of the user with a second set of grammar rules associated with the language being learnt by the user. The learning activity may be a language learning activity arranged to teach the rules that are different based on the comparison.

That is, the learning activity control module may detect, based on the user classification code a set of grammar rules associated with the user's native language. The learning activity control module may then compare those native language grammar rules with the grammar rules associated with the language being learnt (where these are stored in the Grammar Comparison Database). Upon determining the differences between the two sets of rules, the learning activity is selected, changed or modified to teach the rules that are different. Therefore, the system may be arranged to ignore the grammar rules that are common between the language being taught and the native language of the user.

A computer implemented method for teaching a user. The method may comprise a processor performing the following steps. Generating a learning user interface to enable a user to interact with a learning activity and compare a first set of grammar rules associated with the native language of the user with a second set of grammar rules associated with the language being learnt by the user. Generating a learning activity, wherein the learning activity is a language learning activity and may be arranged to teach the rules that are different based on the comparison.

A teaching system may comprise a learning interface module and a learning activity control module. The learning interface module may be arranged to receive user interaction data associated with a user's interaction with a learning interface. The learning activity control module may be arranged to select at least one learning activity from a learning activity database and communicate the selected learning activity to the learning interface module for display on the learning interface. The learning activity may be a language learning activity arranged to teach sight recognition of common syllables.

That is, the learning activity may be arranged to either display words for a short period of defined time, or provide the user with an option to select within a predefined short period of time an icon representing a sound after playing the sound. For example, see the herein description for the Choose or Lose and lashing words games.

A computer implemented method for teaching a user. The method may comprise a processor performing the following steps. Generating a learning user interface to enable a user to interact with a learning activity. Generating a learning activity. The learning activity may be a language learning activity and may be arranged to teach sight recognition of common syllables.

A teaching system may comprise a learning interface module and a learning activity control module. The learning interface module may be arranged to receive user interaction data associated with a user's interaction with a learning interface. The learning activity control module may be arranged to select at least one learning activity from a learning activity database and communicate the selected learning activity to the learning interface module for display on the learning interface. The learning activity may be a language learning activity arranged to teach sight recognition of words by flashing words on the learning interface.

A computer implemented method for teaching a user. The method may comprise a processor performing the following steps. Generating a learning user interface to enable a user to interact with a learning activity. Generating a learning activity. The learning activity may be a language learning activity and may be arranged to teach sight recognition of words by flashing words on the learning interface.

A teaching system may comprise a learning interface module and a learning activity control module. The learning interface module may be arranged to receive user interaction data associated with a user's interaction with a learning interface. The learning activity control module may be arranged to select at least one learning activity from a learning activity database and communicate the selected learning activity to the learning interface module for display on the learning interface. The learning activity control module may be further arranged to measure hesitation while the user interacts with the learning activity and analyze the hesitation to measure automaticity of the interaction.

A computer implemented method for teaching a user. The method may comprise a processor performing the following steps. Generating a learning user interface to enable a user to interact with a language learning activity. Generating a language learning activity. Measuring hesitation while the user interacts with the learning activity and analyze the hesitation to measure automaticity of the interaction.

A computer implemented method for teaching a user. The method may comprise a processor performing the following steps. Receiving user information associated with a user and storing the user information. Obtaining a user classification code based on the user information and storing the user classification code. Selecting at least one learning activity from a learning activity database based on the user classification code. Communicating the selected learning activity to the user.

The method may further comprise the steps of receiving and storing the user interaction data while the user is interacting with the learning activity; communicating the interaction data to a user information database and a learning outcome database against a user ID associated with the user, the user classification code and a learning activity code associated with the learning activity.

The interaction data may comprise data associated with one or more of a skill learned and a result associated with the user interacting with the learning activity.

The method may further comprise the steps of a machine learning system retrieving the interaction data, extracting features from the interaction data and classifying the extracted features.

The method may further comprise the step of the machine learning system operating in one of three modes selected from the group comprising: supervised mode; semi-supervised mode; unsupervised mode.

The method may be for teaching a user a language and the learning activities may be activities for teaching a user to speak, pronounce, understand or learn the language.

The method may further comprise the step of controlling the learning activity based on two or more selected from the group consisting of: the user information; the user classification code, the user ID, interaction data received from the user.

The method may further comprise the step of controlling the learning activity by dynamically optimizing data associated with the selected learning activity.

The user information may comprise one or more of demographic information associated with the user, the user's age, the user's native language, a region where the user did or currently resides, a desired proficiency level of the user associated with a defined language, one or more preferences associated with the user, the user's proficiency level in the user's native language, and the user's proficiency level in the language the user is learning.

The method may further comprise the steps of retrieving a desired proficiency level from the user information and determining which learning activity is selected based on the desired proficiency level.

The method may further comprise the step of selecting the learning activity to be retrieved based on a determined form of the learning activity. The determined form may comprise one or more of a display format that promotes subliminal messaging, a display format that primes the user of at least a portion of the learning activity, audio data that is associated with a voice that has an accent that is associated with the user information, a text format for displaying the lesson data, audio data comprising a controllable variable playback speed, and audio data comprising variable and discernible gaps between discrete audio portions of the audio data.

The learning activity may comprise audio data that is associated with a voice that has an accent that is associated with the user information. The learning activity control module may be further arranged to control and vary the audio data based on the interaction data.

The method may further comprise the steps of controlling and varying the audio data based on a range from varying similarities to the accent associated with the user information to varying similarities to an accent associated with a language being taught.

The method may further comprise the step of optimizing presentation of the selected learning activity based on the interaction data.

The method may further comprise the step of optimizing the presentation of the learning activity by one or more of controlling the speed of playback of an audio and/or video file, and controlling a format of the learning activity to be output.

The method may further comprise the steps of detecting a learning problem associated with a first set of interaction data, comparing the first set of interaction data with the interaction data to determine a match between the first set of interaction data and the interaction data, and controlling the learning activity based on the comparison.

The method may further comprise the steps of capturing audio signals and/or video signals associated with the interaction data, and comparing the captured audio and/or video signals with audio and/or video signals associated with stored interaction data.

The method may further comprise the steps of controlling the learning activity by outputting one or more of instructions on how to correct pronunciation, one or more videos indicating how to correct pronunciation, and one or more sound wave images indicating where pronunciation is inaccurate.

The method may further comprise the step of analyzing the performance of the user while interacting with the learning activity, wherein the performance of the user is analyzed by analyzing the interaction data in association with the user information and the user classification code.

The method may further comprise the steps of detecting hesitation from the user within the interaction data while the user is interacting with the learning activity, and controlling the learning activity based on any detected hesitation.

The method may further comprise the steps of analyzing the interaction data to determine reading ability associated with the user while the user is interacting with the learning activity, and controlling the learning activity based on the determined reading ability and the user classification code.

The method may further comprise the step of determining what the user knows and/or doesn't know based on the interaction data and the user information, and controlling the learning activity based on the determined knowledge or lack of knowledge and the user classification code.

The method may further comprise the step of determining long term memory ability associated with the user based on the interaction data and the user information, and controlling the learning activity based on the determined long term memory ability and the user classification code.

The method may wherein the interaction data is associated with at least one skill learned that is associated with information that has been taught to and learned by the user.

The method may wherein the learning activity comprises at least one learning tool.

The learning tool may be arranged to improve learning outcomes via an optimization process based on at least the interaction data and the user classification ID.

The optimization process may be a multivariable optimization process.

The learning activity may comprise a plurality of learning tools, and the method may further comprise the step of teaching a complete curriculum using the learning tools.

The interaction data may be associated with at least one skill learned that is associated with information that has been taught by the teaching module and learned by the user, and the method further comprises the step of storing each skill learned.

The method may further comprise the step of selecting the learning activity by determining which learning activity has the highest probability of success based on the user classification code.

The method may further comprise the step of obtaining a set of results based on the user classification code and applying a ranking algorithm to the set of results to determine the learning activity for selection.

The method may further comprise the step of teaching the learning activity and revising the learning activity, wherein the revising is separate from the teaching.

The method may further comprise the steps of receiving a list of learning activities arranged in a learning pattern as a defined order, accessing a prerequisite skill list and determining whether the learning pattern is not suitable for the accessed prerequisite skill list, and upon a positive determination, generating an error message.

The interaction data may comprise a plurality of learning units that are associated with information that has been taught to and learned by the user, and the method further comprises the step of determining which of the learning units are to be revised based on the interaction data and the user classification code.

The method may further comprise the step of determining a revision schedule for the user based on revision schedules that provided a successful outcome for other users having the same user classification code.

The method may further comprise the step of determining whether characters of a first word in a first language in the learning activity has more than one sound using a phoneme comparison database, and upon a positive determination, adding visual cues or glyphs to the first word in the learning activity.

The learning activity may comprise a plurality of learning units, the method may further comprise the step of selecting a learning unit from a group of learning units based on matching a learning unit profile with a user profile.

The learning activity may comprise a plurality of learning units. The method may further comprise the steps of comparing the words stored in a user knowledge database with the words in the learning units and selecting a learning unit based on the comparison.

The learning activity may comprise a plurality of learning units, the method further comprise the step of selecting a learning unit from a group of learning units based on matching a learning unit profile with the user classification code.

It will be understood that references to a word may also be a reference to more than one word, a phrase, a part of a word, a syllable or a phoneme.

### INDUSTRIAL APPLICABILITY

The arrangements described are applicable to the computer and data processing industries and particularly for the computer based teaching industries.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A teaching system for teaching a user, the teaching system comprising a learning interface module, a user classification module and a learning activity control module, wherein:
the learning interface module is arranged to receive user information associated with a user and store the user information in a user information database;
the user classification module is arranged to obtain a user classification code based on the user information and store the user classification code in a learning outcome database, and
the learning activity control module is arranged to select at least one learning activity from a learning activity database based on the user classification code and communicate the selected learning activity to the learning interface module for reception by the user.

2. The system of claim 1, wherein the learning interface module is further arranged to receive from the user interaction data while the user is interacting with the learning activity, wherein the interaction data is stored in the user information database;
the learning interface module is further arranged to communicate the interaction data to the user information database and a learning outcome database against a user ID associated with the user, the user classification code and a learning activity code associated with the learning activity.

3. The system of claim 2, wherein the interaction data comprises data associated with one or more of a skill learned and a result associated with the user interacting with the learning activity.

4-5. (canceled)

6. The system of claim 1, wherein the teaching system is a language teaching system for teaching a user a language and the learning activities are activities for teaching a user to speak, pronounce, understand or learn the language.

7. The system of claim 1, wherein the learning activity control module is arranged to control the learning activity based on two or more selected from the group consisting of: the user information; the user classification code; the user ID; interaction data received from the user.

8. The system of claim 1, wherein the learning activity control module is further arranged to control the learning activity by dynamically optimizing data associated with the selected learning activity.

9. (canceled)

10. The system of claim 1, wherein the learning activity control module is further arranged to retrieve a desired proficiency level from the user information in the user information database and determine which learning activity is selected from the learning activity database based on the desired proficiency level.

11. The system of claim 1, wherein the learning activity control module is further arranged to select the learning activity to be retrieved from the learning activity database based on a determined form of the learning activity, wherein the determined form comprises one or more of a display format that promotes subliminal messaging, a display format that primes the user of at least a portion of the learning activity, audio data that is associated with a voice that has an accent that is associated with the user information, a text format for displaying the lesson data, audio data comprising a controllable variable playback speed, and audio data comprising variable and discernible gaps between discrete audio portions of the audio data.

12. The system of claim 1, wherein the learning activity comprises audio data that is associated with a voice that has an accent that is associated with the user information, and the learning activity control module is further arranged to control and vary the audio data based on the interaction data.

13. (canceled)

14. The system of claim 1, wherein the learning activity control module is further arranged to optimize presentation of the selected learning activity based on the interaction data.

15-16. (canceled)

17. The system of claim 1, wherein the learning interface module comprises an audio and/or video capture module arranged to capture audio signals and/or video signals associated with the interaction data, and the learning activity control module is further arranged to compare the captured audio and/or video signals with audio and/or video signals associated with stored interaction data.

18. The system of claim 1, wherein the learning activity control module is further arranged to control the learning activity by outputting one or more of instructions on how to correct pronunciation, one or more videos indicating how to correct pronunciation, and one or more sound wave images indicating where pronunciation is inaccurate.

19-45. (canceled)

46. The teaching system of claim 1, wherein:
the learning interface module is further arranged to receive user interaction data associated with the user's interaction with a learning interface; and
the learning activity control module is further arranged to communicate the selected learning activity to the learning interface module for display on the learning interface,
wherein the learning activity is a language learning activity arranged to output one phoneme per character of a word being taught.

47. (canceled)

48. The teaching system of claim 1 comprising a learning interface module and a learning activity control module, wherein:
the learning interface module is arranged to receive user interaction data associated with a user's interaction with a learning interface; and
the learning activity control module is arranged to select at least one learning activity from a learning activity database and communicate the selected learning activity to the learning interface module for display on the learning interface,
wherein the learning activity is a language learning activity arranged to output a word using a word mark-up system that embeds a pronunciation guide for at least a portion of the word within the word without changing the spelling of the word.

49-51. (canceled)

52. The teaching system of claim 1, wherein:
the learning interface module is further arranged to receive user interaction data associated with the user's interaction with a learning interface; and
the learning activity control module is further arranged to communicate the selected learning activity to the learning interface module for display on the learning interface,
wherein the learning activity is a language learning activity and is arranged to output, in order, phonemes of a word being taught, syllables of the word being taught and then the word being taught.

53-55. (canceled)

56. The teaching system of claim 1, wherein:
the learning interface module is further arranged to receive user interaction data associated with the user's interaction with a learning interface; and
the learning activity control module is further arranged to s communicate the selected learning activity to the learning interface module for display on the learning interface,
wherein the learning activity is a language learning activity and is arranged to display silent characters in a word being taught in a different format to other characters in the word.

57. (canceled)

58. A language teaching system for teaching a language to a user comprising a learning interface module and a learning activity control module, wherein:
the learning interface module is arranged to receive user interaction data associated with a user's interaction with a learning interface; and
the learning activity control module is arranged to select at least one language learning activity from a learning activity database and communicate the selected learning activity to the learning interface module for display on the learning interface,
wherein the learning activity control module is further arranged to detect an accent selection from the user and the learning activity is arranged to output audio signals based on the accent selection, wherein initial learning activities output audio signals in the user's native accent and subsequently learning activities output audio signals in an accent of a native speaker of the language being taught.

59-65. (canceled)

66. The teaching system of claim 1, wherein:
the learning interface module is further arranged to receive user interaction data associated with the user's interaction with a learning interface; and
the learning activity control module is further arranged to communicate the selected learning activity to the learning interface module for display on the learning interface,
wherein the learning activity is a language learning activity and is arranged to generate non-words.

67. (canceled)

68. The teaching system of claim 1, wherein:
the learning interface module is further arranged to receive user interaction data associated with the user's interaction with a learning interface; and
the learning activity control module is further arranged to communicate the selected learning activity to the learning interface module for display on the learning interface,
wherein the learning activity control module is further arranged to compare a first set of grammar rules associated with the native language of the user with a second set of grammar rules associated with the language being learnt by the user, and
the learning activity is a language learning activity arranged to teach the rules that are different based on the comparison.

69.-71. (canceled)

72. A teaching system comprising a learning interface module and a learning activity control module, wherein:
the learning interface module is arranged to receive user interaction data associated with a user's interaction with a learning interface; and
the learning activity control module is arranged to select at least one learning activity from a learning activity database and communicate the selected learning activity to the learning interface module for display on the learning interface, and
the learning activity is a language learning activity arranged to teach sight recognition of words by flashing words on the learning interface, capture an utterance of the user, and automatically compare the captured utterance using a voice recognition module to determine if the word has been recognized correctly.

73-116. (canceled)
